(19) United States
(12) Patent Application Publication
(10) Pub. No.: US 2012/0249573 A1
(43) Pub. Date: Oct. 4, 2012

(54) IMAGE PROCESSING APPARATUS, IMAGE PROCESSING METHOD, AND COMPUTER-READABLE MEDIUM

(75) Inventor: Natsumi MIYAZAWA, Kanagawa (JP)

(73) Assignee: FUJI XEROX CO., LTD., Tokyo (JP)

(21) Appl. No.: 13/252,379

(22) Filed: Oct. 4, 2011

(30) Foreign Application Priority Data
Mar. 29, 2011 (JP) 2011-071776

(51) Int. Cl. G09G 5/02

(52) U.S. Cl. 345/596

(57) ABSTRACT

An image processing apparatus includes an image receiving unit, a screen-information receiving unit, a pixel-block extraction unit, a halftone-dot extraction unit, and a halftone-dot adding unit. The image receiving unit receives an image. The screen-information receiving unit receives screen information concerning screening which has been performed on the received image. The pixel-block extraction unit extracts pixel blocks which are possibly halftone dots included in the received image. The halftone-dot extraction unit extracts, on the basis of the screen information, a pixel block which is a halftone dot among the pixel blocks extracted by the pixel-block extraction unit. The halftone-dot adding unit adds, on the basis of the screen information, a halftone dot at a position at which no pixel block has been extracted by the pixel-block extraction unit.

### CROSS-REFERENCE TO RELATED APPLICATIONS

This application is based on and claims priority under 35 USC 119 from Japanese Patent Application No. 2011-071776 filed Mar. 29, 2011.

### BACKGROUND

(i) Technical Field

The present invention relates to an image processing apparatus, an image processing method, and a computer-readable medium storing a program.

(ii) Related Art

Processes associated with halftone dots of images exist.

### SUMMARY

According to an aspect of the invention, there is provided an image processing apparatus including an image receiving unit, a screen-information receiving unit, a pixel-block extraction unit, a halftone-dot extraction unit, and a halftone-dot adding unit. The image receiving unit receives an image. The screen-information receiving unit receives screen information concerning screening which has been performed on the image received by the image receiving unit, thereby performing a screen-information reception process. The pixel-block extraction unit extracts pixel blocks which are possibly halftone dots included in the image received by the image receiving unit, thereby performing a pixel-block extraction process. The halftone-dot extraction unit extracts, on the basis of the screen information received by the screen-information receiving unit, a pixel block which is a halftone dot among the pixel blocks extracted by the pixel-block extraction unit, thereby performing a halftone-dot extraction process. The halftone-dot adding unit adds, on the basis of the screen information received by the screen-information receiving unit, a halftone dot at a position at which no pixel block has been extracted by the pixel-block extraction unit, thereby performing a halftone-dot addition process.

### BRIEF DESCRIPTION OF THE DRAWINGS

Exemplary embodiment(s) of the present invention will be described in detail based on the following figures, wherein:

FIG. 1 is a module-configuration diagram schematically illustrating an example of a configuration of an image processing apparatus according to a first exemplary embodiment;

FIG. 2 is a flowchart illustrating an example of a process in the first exemplary embodiment;

FIG. 3 is an explanatory diagram illustrating an example of screen information concerning screening;

FIG. 4 is a flowchart illustrating an example of a process performed by a halftone-dot-pixel extraction module;

FIG. 5 is an explanatory diagram illustrating an example of the process performed by the halftone-dot-pixel extraction module;

FIG. 6 is an explanatory diagram illustrating an example of the relationships, which are used by the halftone-dot-pixel extraction module, between the number of flags and determination of a halftone dot;

FIG. 7 is a flowchart illustrating an example of a process performed by a halftone-dot-pixel adding module;

FIG. 8 is an explanatory diagram illustrating an example of the process performed by the halftone-dot-pixel adding module;

FIG. 9 is an explanatory diagram illustrating an example of the relationships, which are used by the halftone-dot-pixel adding module, between the number of flags and determination of a halftone dot;

FIG. 10 is an explanatory diagram illustrating an example of a process performed by a separation-signal generating module;

FIG. 11 is a module-configuration diagram schematically illustrating an example of a configuration of an image processing apparatus according to each of second and third exemplary embodiments;

FIG. 12 is a flowchart illustrating an example of a process in the second exemplary embodiment;

FIG. 13 is a flowchart illustrating an example of a process performed by a halftone-dot-region extraction module;

FIG. 14 is an explanatory diagram illustrating an example of the process performed by the halftone-dot-region extraction module;

FIG. 15 is an explanatory diagram illustrating an example of the process performed by the halftone-dot-region extraction module;

FIG. 16 is a flowchart illustrating an example of a process in the third exemplary embodiment;

FIG. 17 is a flowchart illustrating an example of a process performed by the halftone-dot-region extraction module;

FIG. 18 is an explanatory diagram illustrating an example of the process performed by the halftone-dot-region extraction module;

FIG. 19 is an explanatory diagram illustrating an example of the process performed by the halftone-dot-region extraction module;

FIG. 20 is an explanatory diagram illustrating an example of the process performed by the halftone-dot-region extraction module;

FIG. 21 is a module-configuration diagram schematically illustrating an example of a configuration of an image processing apparatus according to a fourth exemplary embodiment;

FIG. 22 is a flowchart illustrating an example of a process in the fourth exemplary embodiment;

FIG. 23 is a module-configuration diagram schematically illustrating an example of a configuration of an image processing apparatus according to a fifth exemplary embodiment;

FIG. 24 is a flowchart illustrating an example of a process in the fifth exemplary embodiment;

FIG. 25 is an explanatory diagram illustrating an example of a process that is performed on a black region by a halftone-dot-pixel extraction module;

FIGS. 26A and 26B are explanatory diagrams illustrating an example of the process that is performed on a black region in a case in which halftone dots are in contact with straight lines; and

FIG. 27 is a block diagram illustrating an example of a hardware configuration of a computer that realizes a present exemplary embodiment.

### DETAILED DESCRIPTION

Hereinafter, examples of exemplary embodiments for realizing the present invention will be described with reference to the figures.

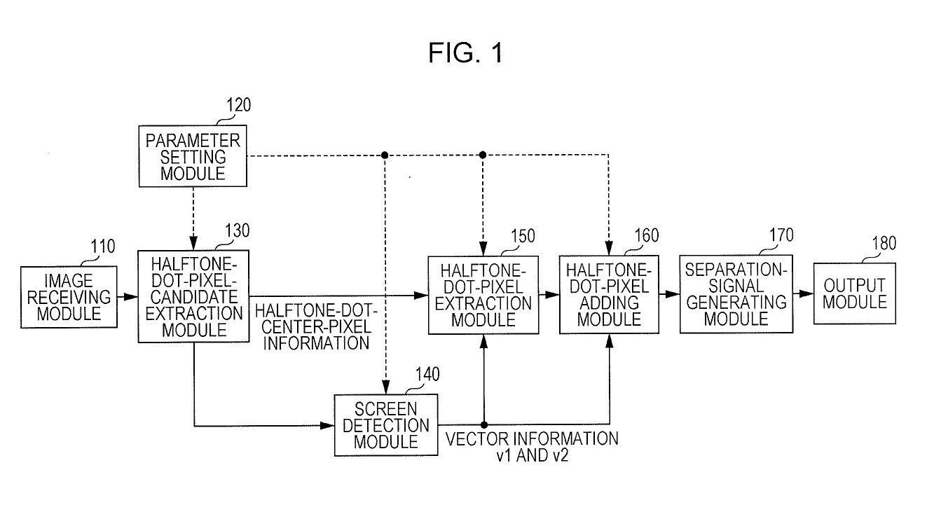

FIG. 1 is a module-configuration diagram schematically illustrating an example of a configuration of an image processing apparatus according to a first exemplary embodiment.

Note that the term “modules” refers to typically and logically separable components of software (a computer program), hardware, or the like. Accordingly, the term “modules” in the present exemplary embodiment refers to not only modules in a computer program, but also modules in a hardware configuration. Thus, in the present exemplary embodiment, a description of computer programs for functioning as the modules (a program for causing a computer to perform each procedure, a program for causing a computer to function as each unit, and a program for causing a computer to realize each function) is included, and a description of a system and method is also included. Note that, for convenience of description, the term “store”, the term “cause an object to store”, and terms having meanings the same as those of the terms are used. When an exemplary embodiment is realized using a computer program, the terms mean “causing a storage device to store” or “performs control so that a storage device is caused to store. Furthermore, modules may correspond to functions in a one-to-one manner. However, in a case of implementation, one module may be configured using one program, or multiple modules may be configured using one program. In contrast, one module may be configured using multiple programs. Moreover, multiple modules may be executed by one computer, or one module may be executed by multiple computers that are capable of operating in a distribution or parallel environment. Note that, in one module, another module may be included. Additionally, hereinafter, the term “connection” is used to express not only physical connection, but also logical connection (reception of data, instructions, reference relationships among data, and so forth). The term “determined in advance” refers to “determined before” a target process is performed. The term “determined in advance” not only includes “determined before” a process according to the exemplary embodiment starts, but also includes, in accordance with the current state and condition or in accordance with the previous state and condition, “determined before” a target process starts even after a process according to the exemplary embodiment has started.

In addition, the term “system” or the term “apparatus” refers to not only a system or apparatus having a configuration in which multiple computers, pieces of hardware, apparatuses, or the like are connected to each other via a communication medium such as a network (including communication connection established in one-to-one manner), but also a system or apparatus that is realized by one computer, one piece of hardware, one apparatus, or the like. The term “apparatus” and the term “system” are used as terms having the same meaning. As a matter of course, the meaning of the term “system” does not include the meaning of only a social “mechanism” (a social system) that represents agreement among men.

Furthermore, target information is read from a storage device for each of processes that are performed by individual modules or for each of processes in a case in which the multiple processes are performed in a module. After the process is performed, a result of the process is written into the storage device. Accordingly, a description of reading from the storage device before the process is performed and writing into the storage device after the process is performed is omitted in some cases. Note that, here, examples of the storage device may include a hard disk (HD), a random-access memory (RAM), an external storage medium, a storage device that is connected via a communication line, and a register that is included in a central processing unit (CPU).

The image processing apparatus according to the present exemplary embodiment performs a process associated with halftone dots included in an image. As shown in the example illustrated in FIG. 1, the image processing apparatus according to the present exemplary embodiment includes an image receiving module 110, a parameter setting module 120, a halftone-dot-pixel-candidate extraction module 130, a screen detection module 140, a halftone-dot-pixel extraction module 150, a halftone-dot-pixel adding module 160, a separation-signal generating module 170, and an output module 180.

The image receiving module 110 is connected to the halftone-dot-pixel-candidate extraction module 130. The image receiving module 110 receives an image, and passes on the image to the halftone-dot-pixel-candidate extraction module 130. Examples of reception of an image include the following: reading of an image using a scanner, a camera, or the like; reception of an image by facsimile or the like from an external device via a communication line; and reading of an image that is stored in, for example, a hard disk (examples of the hard disk include a hard disk that is implemented in a computer, and a hard disk that is connected via a network). Although the image is a binary image, not only black and white may be used in the image, but also colors may be used (for example, a binary image having individual colors in a YMCK color specification system). Note that black and white are used as examples in the description given below. The number of images to be received may be one or more. Furthermore, the contents of the image may be a document used in business, a brochure for advertising, or the like. Note that there is a high probability that a region which has been subjected to screening exists in the image. Furthermore, the resolution of the image is a resolution that is typically considered as a high resolution, and, for example, is equal to or higher than 600 dpi. A desired resolution of the image is equal to or hither than 2400 dpi that is suitable for printing.

The parameter setting module 120 is connected to the halftone-dot-pixel-candidate extraction module 130, the screen detection module 140, the halftone-dot-pixel extraction module 150, and the halftone-dot-pixel adding module 160. The parameter setting module 120 sets parameters that are to be used in the halftone-dot-pixel-candidate extraction module 130, the screen detection module 140, the halftone-dot-pixel extraction module 150, and the halftone-dot-pixel adding module 160. The parameter setting module 120 sets, for example, a size of reference ranges, which are described below, as a parameter.

The halftone-dot-pixel-candidate extraction module 130 is connected to the image receiving module 110, the parameter setting module 120, the screen detection module 140, and the halftone-dot-pixel extraction module 150. The halftone-dot-pixel-candidate extraction module 130 extracts pixel blocks that can be halftone dots included in the image received by the image receiving module 110. The term “pixel block” refers to a region of a pixel group in which pixels are linked to each other. The term “pixels linked to each other” indicates the existence of a pixel that is adjacent to a certain pixel and that has a color the same as the color of the certain pixel. The pixel adjacent to a certain pixel may be a pixel that is positioned in an oblique direction. Black pixels are used as examples in the description given below.

Regarding the term “extraction of pixel blocks that can be halftone dots”, a specific example of a process may refer to a process of extracting the position of a halftone dot. The position of a halftone dot may be the position of a representative point of the halftone dot. For example, the position of a halftone dot may be the position of the center of the halftone dot, the position of the center of a rectangle circumscribing the halftone dot, or the position of the center of gravity of the halftone dot. Note that the position of the center of a halftone dot is used as an example in the description given below. Hereinafter, a central pixel of a halftone dot is referred to as a “halftone-dot pixel”. An existing technique may be used as an extraction method. For example, the center of a black region may be extracted by obtaining a skeleton of the black region. Alternatively, the center of a rectangle circumscribing a halftone dot may be extracted, or the center of gravity of the black region may be extracted. The halftone-dot-pixel-candidate extraction module 130 passes on the position of the center of a halftone dot as halftone-dot-center-pixel information to the screen detection module 140 and the halftone-dot-pixel extraction module 150. For example, the halftone-dot-center-pixel information may be an image of a halftone dot having a pixel located at the center thereof.

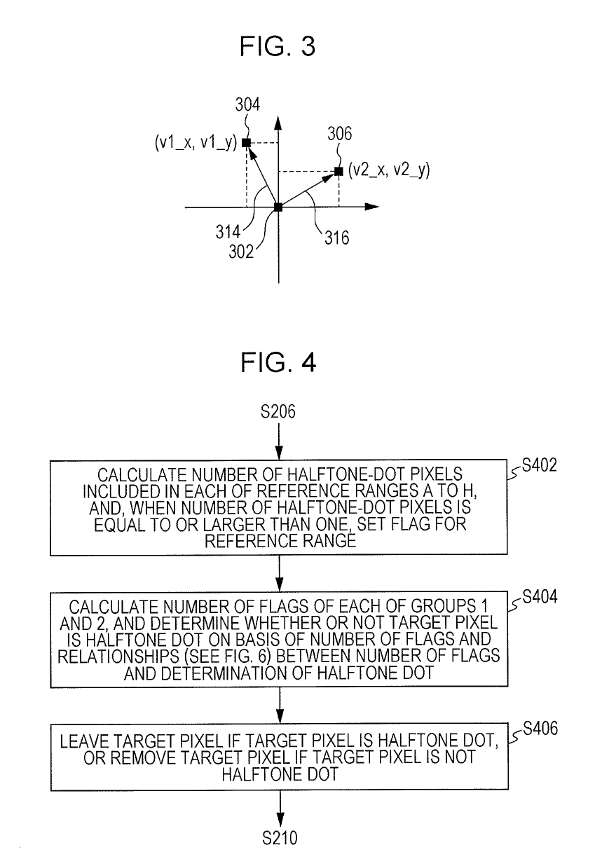

The screen detection module 140 is connected to the parameter setting module 120, the halftone-dot-pixel-candidate extraction module 130, the halftone-dot-pixel extraction module 150, and the halftone-dot-pixel adding module 160. The screen detection module 140 detects screen information concerning screening on the basis of the halftone-dot-center-pixel information that the halftone-dot-pixel-candidate extraction module 130 has passed on. The screen information concerning screening includes a screen angle and a screen ruling. Any information indicating a screen angle and a screen ruling, such as screen vectors illustrated in FIG. 3, may be used as the screen information concerning screening. FIG. 3 is an explanatory diagram illustrating an example of the screen information concerning screening. A halftone-dot pixel 304 (v1_x, v1_y) and a halftone-dot pixel 306 (v2_x, v2_y) that are adjacent to a halftone-dot pixel 302 (which is considered as an origin (0, 0)) that is a target point are extracted. Two screen vectors, i.e., a screen vector 314 from the halftone-dot pixel 302 to the halftone-dot pixel 304 and a screen vector 316 from the halftone-dot pixel 302 to the halftone-dot pixel 306, are extracted. A statistical process (for example, a process of obtaining an average value) is performed for the screen vectors 314 and 316, thereby extracting two screen vectors that represent a halftone dot. For example, an angle between the screen vector 316 (or the screen vector 314) and the X axis corresponds to a screen angle. A value obtained by dividing a resolution by the magnitude of the screen vector 316 (or the screen vector 314) corresponds to a screen ruling.

The halftone-dot-pixel extraction module 150 is connected to the parameter setting module 120, the halftone-dot-pixel-candidate extraction module 130, the screen detection module 140, and the halftone-dot-pixel adding module 160. The halftone-dot-pixel extraction module 150 receives, from the screen detection module 140, the screen information concerning screening that has been performed on the image received by the image receiving module 110. The halftone-dot-pixel extraction module 150 extracts, on the basis of the screen information concerning screening, a pixel block that is a halftone dot among the pixel blocks that have been extracted by the halftone-dot-pixel-candidate extraction module 130. Extraction of a halftone dot includes removal of, when a pixel block that is a halftone dot exists at a position at which no halftone dot is supposed to exist, the halftone dot. Removal of such a halftone dot leads to extraction of a halftone dot that exists at a position at which a halftone dot is supposed to exist.

The halftone-dot-pixel adding module 160 is connected to the parameter setting module 120, the screen detection module 140, the halftone-dot-pixel extraction module 150, and the separation-signal generating module 170. The halftone-dot-pixel adding module 160 receives, from the screen detection module 140, the screen information concerning screening that has been performed on the image received by the image receiving module 110. The halftone-dot-pixel adding module 160 adds, on the basis of the screen information concerning screening, a halftone dot at a position at which no pixel block has been extracted by the halftone-dot-pixel-candidate extraction module 130. Although there are halftone-dot pixels that should be extracted as halftone dots by the halftone-dot-pixel extraction module 150, even in a case in which a halftone-dot pixel may be extracted at an incorrect position, in a case in which no halftone-dot pixel may exist originally, or in a case in which misregistration of a halftone-dot pixel may occur, a halftone dot can be extracted.

Note that addition of a halftone dot may include addition of a halftone-dot pixel.

The halftone-dot-pixel extraction module 150 and the halftone-dot-pixel adding module 160 may determine, using criteria based on the number of pixel blocks that exist around a target position, whether or not a halftone dot is supposed to exist at the target position. The criteria used by the halftone-dot-pixel extraction module 150 and the halftone-dot-pixel adding module 160 may be different from each other.

Furthermore, in the example illustrated in FIG. 1, the halftone-dot-pixel adding module 160 performs a process for a result of a process performed by the halftone-dot-pixel extraction module 150. However, the halftone-dot-pixel extraction module 150 may perform a process for a result of a process performed by the halftone-dot-pixel adding module 160. Alternatively, the halftone-dot-pixel extraction module 150 and the halftone-dot-pixel adding module 160 may perform processes in parallel, and results of the processes may be consolidated.

The separation-signal generating module 170 is connected to the halftone-dot-pixel adding module 160 and the output module 180. The separation-signal generating module 170 generates, on the basis of a result of the processes performed by the halftone-dot-pixel extraction module 150 and the halftone-dot-pixel adding module 160, a signal that enables a region which has been subjected to screening in the image received by the image receiving module 110 to be separated. Here, the signal may be information indicating a region (a halftone-dot region) that has been subjected to screening. For example, the signal may be information concerning the region (for example, upper-left coordinates, a width, and a height), or may be a mask image used for extraction of the halftone-dot region. A region that has been subjected to screening is generated so as to include the halftone dot extracted by the halftone-dot-pixel extraction module 150 and the halftone dot added by the halftone-dot-pixel adding module 160.

The output module 180 is connected to the separation-signal generating module 170. The output module 180 adds the signal, which has been generated by the separation-signal generating module 170 to the image, which has been received by the image receiving module 110, and outputs the image. For example, the signal may be added to the image so that the signal serves as an attribute of the image, and the image may be output. Examples of outputting of an image include the following: printing of an image with a printing apparatus such as a printer; display of an image on a display apparatus such as a display; transmission of an image with an image transmitting apparatus such as a facsimile machine; writing of an image into an image storage apparatus such as an image database; storage of an image onto a storage medium such as a memory card; and passing-on of an image to another information processing apparatus. Furthermore, in a case of outputting an image with a printing apparatus or the like, image processing that is suitable for each region may be performed.

Note that, in the present exemplary embodiment, when the screen information is known, a configuration in which the screen detection module 140 is not included may be used. The halftone-dot-pixel extraction module 150 and the halftone-dot-pixel adding module 160 may receive the known screen information. The screen information in this case may be specified using a keyboard or the like operated by an operator. Alternatively, the screen information in this case may be stored in a storage apparatus that can be accessed by the halftone-dot-pixel extraction module 150 and the halftone-dot-pixel adding module 160, and may be read from the storage apparatus.

Note that a configuration in which the separation-signal generating module 170 is not provided may be used. When the separation-signal generating module 170 is not provided, the output module 180 outputs the image to which a halftone dot is added by the halftone-dot-pixel adding module 160.

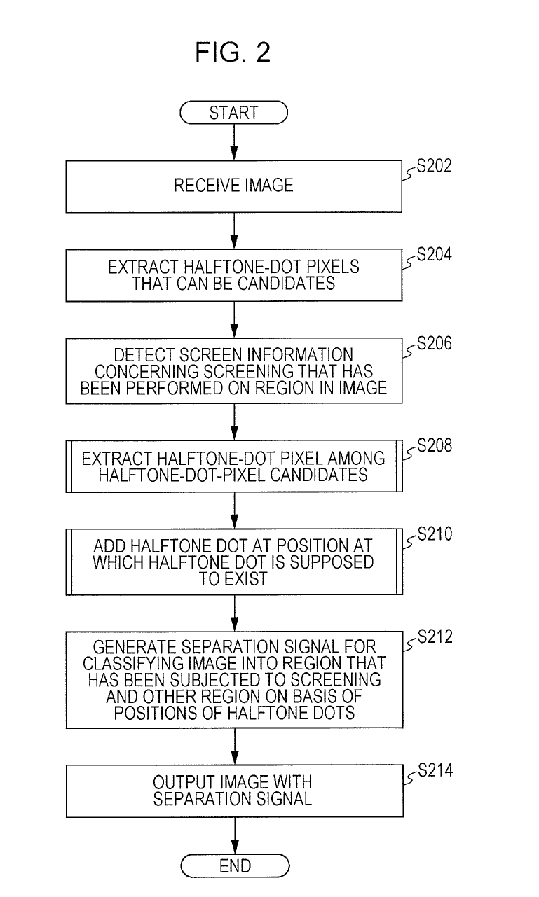

FIG. 2 is a flowchart illustrating an example of a process in the first exemplary embodiment.

In step S202, the image receiving module 110 receives an image.

In step S204, the halftone-dot-pixel-candidate extraction module 130 extracts, as halftone-dot-pixel candidates, halftone-dot pixels that can be candidates.

In step S206, the screen detection module 140 detects screen information concerning screening that has been performed on a region in the image. For example, the screen vectors 314 and 316 illustrated as examples in FIG. 3 are detected.

In step S208, the halftone-dot-pixel extraction module 150 performs a process of extracting a halftone-dot pixel among the halftone-dot-pixel candidates. In other words, whether or not a halftone-dot pixel is a halftone dot is determined, and a halftone-dot pixel that has been determined to be a halftone dot is left. This process will be described in detail with reference to FIGS. 4 to 6.

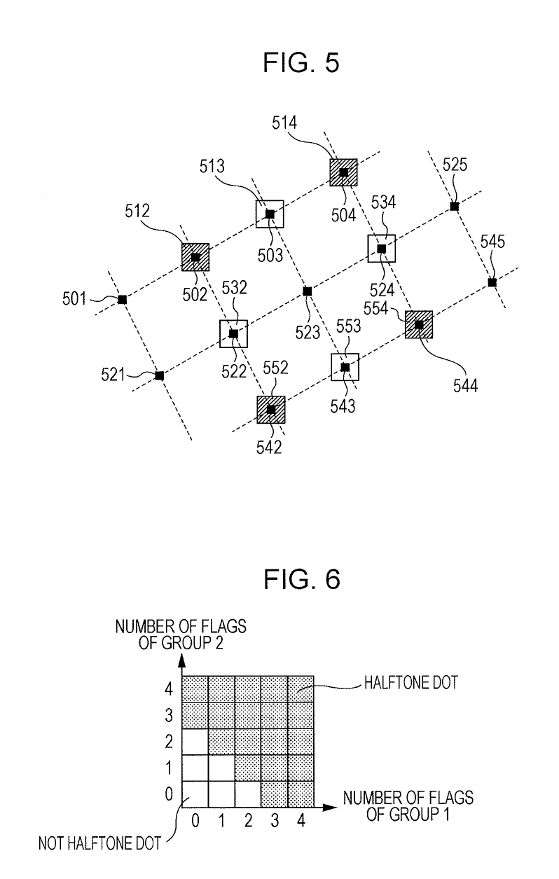

FIG. 4 is a flowchart illustrating an example of the process performed by the halftone-dot-pixel extraction module 150. FIG. 5 is an explanatory diagram illustrating an example of the process performed by the halftone-dot-pixel extraction module 150.

In step S402, the number of halftone-dot pixels that are included in each of reference ranges A to H (reference ranges A513, B534, C553, D532, E512, F514, G554, and H552) is calculated. Regarding to each of the reference ranges, when the number of halftone-dot pixels included in the reference range is equal to or larger than one, a flag is set for the reference range.

Note that, referring to FIG. 5, it is supposed that a halftone-dot pixel exists at a halftone-dot position 523. If a halftone dot exists at the halftone-dot position 523 (if a region including the halftone-dot position 523 has been subjected to screening), there is a high probability that a halftone dot also exists at each of halftone-dot positions 501 to 504, 521 to 524, and 542 to 544. The halftone-dot positions (501 to 504, 521, 522, 524, and 542 to 544) are positions that are relatively defined by the screen vectors 314 and 316 using the halftone-dot position 523 as a base point.

The reference range A513 indicates a region that includes the halftone-dot position 503 and that exists at the end point of the screen vector 314.

The reference range B534 indicates a region that includes the halftone-dot position 524 and that exists at the end point of the screen vector 316.

The reference range C553 indicates a region that includes the halftone-dot position 543 and that exists at the end point of the reciprocal vector of the screen vector 314 (which is a vector whose direction is opposite to the direction of the screen vector 314).

The reference range D532 indicates a region that includes the halftone-dot position 522 and that exists at the end point of the reciprocal vector of the screen vector 316 (which is a vector whose direction is opposite to the direction of the screen vector 316).

The reference range E512 indicates a region that includes the halftone-dot position 502 and that exists at the end point of the resultant vector of the screen vector 314 and the reciprocal vector of the screen vector 316.

The reference range F514 indicates a region that includes the halftone-dot position 504 and that exists at the end point of the resultant vector of the screen vector 314 and the screen vector 316.

The reference range G554 indicates a region that includes the halftone-dot position 544 and that exists at the end point of the resultant vector of the reciprocal vector of the screen vector 314 and the screen vector 316.

The reference range H552 indicates a region that includes the halftone-dot position 542 and that exists at the end point of the resultant vector of the reciprocal vector of the screen vector 314 and the reciprocal vector of the screen vector 316.

Note that each of the regions indicates a region including multiple pixels. The parameter setting module 120 sets a size of the region. The region may be, for example, a region having a size of 3×3, 4×4, or 5×5.

As described above, the regions that are located in eight directions (the reference ranges A513, B534, C553, D532, E512, F514, G554, and H552 with respect to the halftone-dot position 523) are used for determination. Additionally, in regions surrounding a target pixel, halftone-dot pixels representing a small character or a complicated Chinese character may be interspersed in an irregular manner, or bold characters may be adjacent to each other. Even in such cases, a halftone dot can be extracted.

The reference ranges A513, B534, C553, and D532 are grouped into a group 1, and the reference ranges E512, F514, G554, and H552 are grouped into a group 2.

In step S404, the number of flags of each of the groups 1 and 2 is calculated. Whether or not a target pixel is a halftone dot is determined on the basis of the number of flags and the relationships (see FIG. 6) between the number of flags and determination of a halftone dot.

FIG. 6 is an explanatory diagram illustrating an example of the relationships, which are used by the halftone-dot-pixel extraction module 150, between the number of flags and determination of a halftone dot.

A relationship between the number of flags and determination of a halftone dot is represented by a combination of the number of flags of the group 1 and the number of flags of the group 2, i.e., an expression (the number of flags of the group 1, the number of flags of the group 2). When the expression (the number of flags of the group 1, the number of flags of the group 2) is one of (0, 0), (0, 1), (0, 2), (1, 0), (1, 1), and (2, 0), it is determined that the target pixel is not a halftone dot. When the expression (the number of flags of the group 1, the number of flags of the group 2) is one of the other combinations, it is determined that the target pixel is a halftone dot. Accordingly, conditions are set so that, even when the target pixel represents an angular portion, the target pixel is recognized as a halftone dot.

Furthermore, another determination method may be used. For example, even when the reference ranges are not grouped into two groups, a method may be used, in which, when the total number of flags in the eight directions is equal to or larger than three, it is determined that the target pixel is a halftone dot, and in which, when the total number of flags in the eight directions is a value that is not equal to or larger than three, it is determined that the target pixel is not a halftone dot.

In step S406, when it has been determined in step S404 that the target pixel is a halftone dot, the target pixel that is located at the halftone-dot position 523 is left. When it has been determined in step S404 that the target pixel is not a halftone dot, the target pixel that is located at the halftone-dot position 523 is removed.

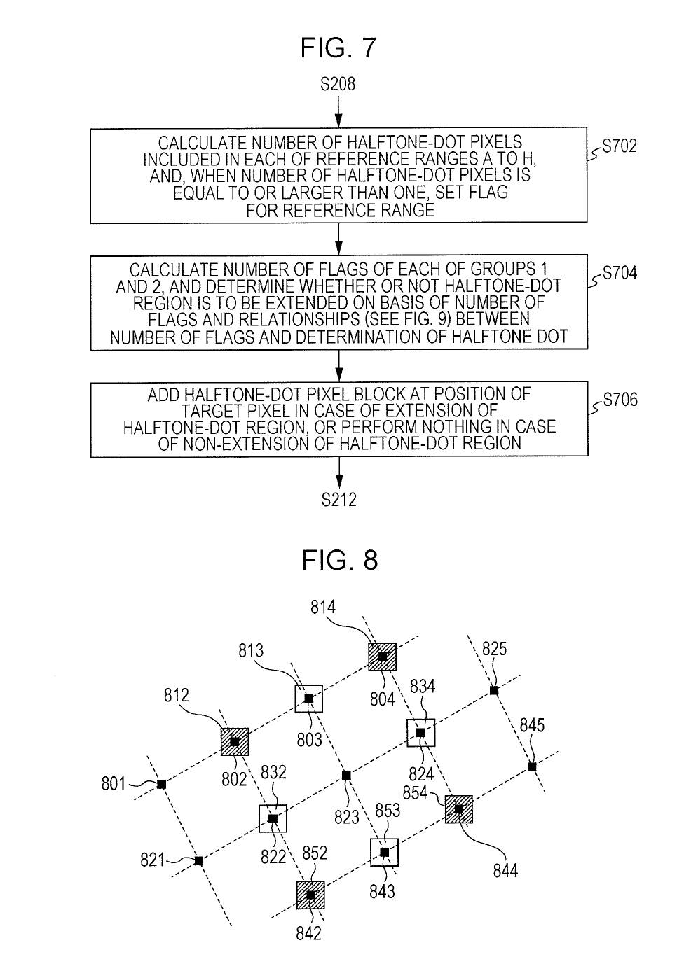

In step S210, the halftone-dot-pixel adding module 160 performs a process of adding a halftone dot at a position at which a halftone dot is supposed to exist. A hole is filled by newly adding a halftone-dot pixel in a region that is supposed to be a halftone-dot region. This process will be described in detail with reference to FIGS. 7 to 9.

FIG. 7 is a flowchart illustrating an example of the process performed by the halftone-dot-pixel adding module 160. FIG. 8 is an explanatory-diagram illustrating an example of the process performed by the halftone-dot-pixel adding module 160.

In step S702, the number of halftone-dot pixels that are included in each of reference ranges A to H (reference ranges A813, B834, C853, D832, E812, F814, G854, and H852) is calculated. Regarding to each of the reference ranges, when the number of halftone-dot pixels included in the reference range is equal to or larger than one, a flag is set for the reference range.

Note that, referring to FIG. 8, it is supposed that a halftone-dot pixel does not exist at a halftone-dot position 823. If a halftone dot originally exists at the halftone-dot position 823 (if a region including the halftone-dot position 823 has been subjected to screening), there is a high probability that a halftone dot also exists at each of halftone-dot positions 801 to 804, 821 to 824, and 842 to 844 that have been calculated using the screen vectors 314 and 316.

The reference ranges A813, B834, C853, D832, E812, F814, G854, and H852 that are illustrated in FIG. 8 are equivalent to the reference ranges A513, B534, C553, D532, E512, F514, G554, and H552, respectively, that are illustrated in FIG. 5.

The reference ranges A813, B834, C853, and D832 are grouped into a group 1, and the reference ranges E812, F814, G854, and H852 are grouped into a group 2.

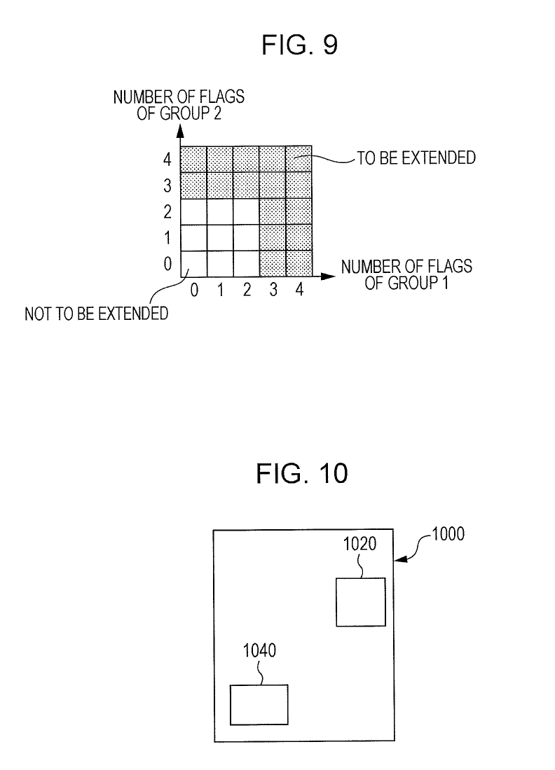

In step S704, the number of flags of each of the groups 1 and 2 is calculated. Whether or not a halftone-dot region is to be extended is determined on the basis of the number of flags and the relationships (see FIG. 9) between the number of flags and determination of a halftone dot.

FIG. 9 is an explanatory diagram illustrating an example of the relationships, which are used by the halftone-dot-pixel adding module 160, between the number of flags and determination of a halftone dot.

A relationship between the number of flags and determination of a halftone dot is represented by a combination of the number of flags of the group 1 and the number of flags of the group 2, i.e., an expression (the number of flags of the group 1, the number of flags of the group 2). When the expression (the number of flags of the group 1, the number of flags of the group 2) is one of (0, 3), (0, 4), (1, 3), (1, 4), (2, 3), (2, 4), (3, 0), (3, 1), (3, 2), (3, 3), (3, 4), (4, 0), (4, 1), (4, 2), (4, 3), and (4, 4), it is determined that the halftone-dot region is to be extended (that the halftone-dot position is a position at which a halftone dot originally exists). When the expression (the number of flags of the group 1, the number of flags of the group 2) is one of the other combinations, it is determined that the halftone-dot region is not to be extended (that the halftone-dot position is not a position at which a halftone dot exists). Accordingly, conditions are set so that, when lines indicating multiple directions selected among the eight directions are connected to each other, a region defined by the lines includes the target pixel or the target pixel exists on at least one of the lines. The example illustrated in FIG. 9 is an example of combinations of the number of flags of the group 1 and the number of flags of the group 2, and the combinations are provided so that a region defined by the lines can include the target pixel (the number of flags of the group 1 is equal to or larger than three or the number of flags of the group 2 is equal to or larger than three).

Furthermore, in the example illustrated in FIG. 9, when either the number of flags of the group 1 or the number of flags of the group 2 is two, determination of whether or not the target pixel exists on at least one of the lines that indicate multiple directions and that are connected to each other may be added.

Additionally, the relationships between the number of flags and determination of a halftone dot, which are shown in the example illustrated in FIG. 9, are adjusted by an operator, whereby the operator may set the degree of extension. For example, when it is difficult to perform the above-mentioned additional determination because of the scale of processing, if a condition where the number of flags of the group 1 is two and the number of flags of the group 2 is two is also added to the conditions under which the halftone-dot region is to be extended, the target pixel can almost be included in the halftone-dot region although a portion that is one portion of the halftone-dot region and that does not include the target pixel is also extended so that the halftone-dot region is too extended.

Moreover, the edge of the halftone-dot region may be increased in accordance with post-processing. However, for example, when it is desired to assuredly fill a hole that exists in the halftone-dot region, regarding the relationships between the number of flags and determination of a halftone dot, which are shown in the example illustrated in FIG. 9, a setting may be set so as to increase a region to which the label “to be extended” is added.

In step S706, in a case of extension of the halftone-dot region, a halftone-dot pixel block is added at a position of the target pixel. In a case of non-extension of the halftone-dot region, nothing is performed.

In step S212, the separation-signal generating module 170 generates a separation signal for classifying the image into a region that has been subjected to screening and the other region on the basis of positions of halftone dots. FIG. 10 is an explanatory diagram illustrating an example of a process performed by the separation-signal generating module 170. On the basis of the processes that have been performed, it is determined that an image 1000 which has been received in step S202 has screen regions 1020 and 1040. The generated separation signal may be information with which the screen regions 1020 and 1040 can be extracted.

In step S214, the output module 180 outputs the image with the separation signal.

### Second Exemplary Embodiment

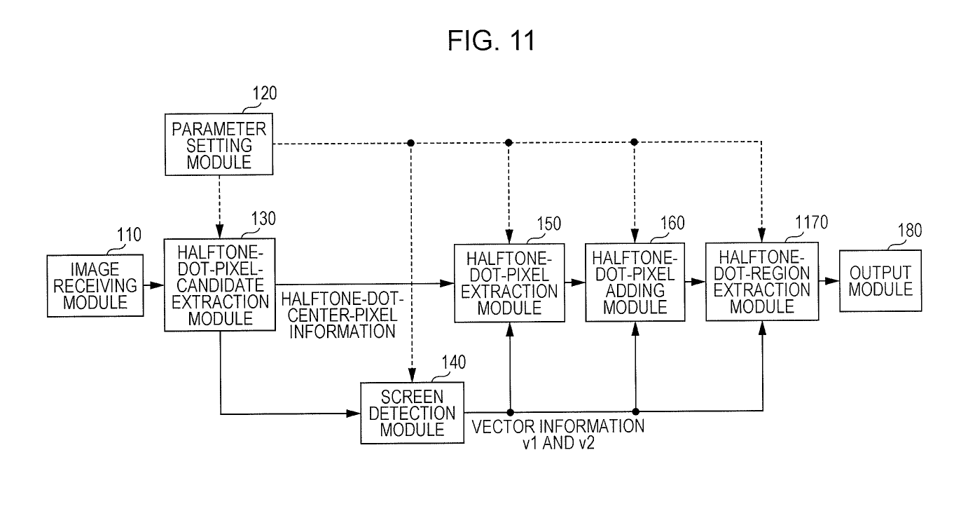

FIG. 11 is a module-configuration diagram schematically illustrating an example of a configuration of an image processing according to a second exemplary embodiment.

The image processing apparatus according to the second exemplary embodiment outputs, as a binary image, an image of a region that has been subjected to at least screening. As shown in the example illustrated in FIG. 11, the image processing apparatus according to the second exemplary embodiment includes an image receiving module 110, a parameter setting module 120, a halftone-dot-pixel-candidate extraction module 130, a screen detection module 140, a halftone-dot-pixel extraction module 150, a halftone-dot-pixel adding module 160, a halftone-dot-region extraction module 1170, and an output module 180. Note that, hereinafter, elements whose types are the same as the types of the elements in the first exemplary embodiment are denoted by the same reference numerals, and a redundant description is omitted.

The halftone-dot-pixel adding module 160 is connected to the parameter setting module 120, the screen detection module 140, the halftone-dot-pixel extraction module 150, and the halftone-dot-region extraction module 1170.

The separation-signal generating module 170 is connected to the parameter setting module 120, the screen detection module 140, the halftone-dot-pixel adding module 160, and the output module 180. The halftone-dot-region extraction module 1170 receives, from the screen detection module 140, screen information concerning screening that has been performed on an image received by the image receiving module 110. The halftone-dot-region extraction module 1170 generates, on the basis of the screen information and a result of the processes performed by the halftone-dot-pixel extraction module 150 and the halftone-dot-pixel adding module 160, a binary image of a region that has been subjected to screening in the image received by the image receiving module 110.

The output module 180 is connected to the halftone-dot-region extraction module 1170.

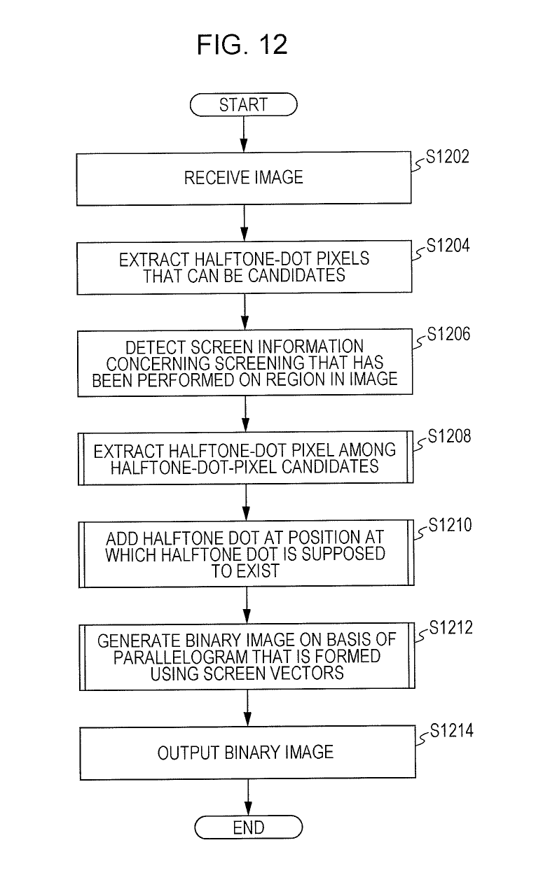

FIG. 12 is a flowchart illustrating an example of a process in the second exemplary embodiment.

In step S1202, the image receiving module 110 receives an image.

In step S1204, the halftone-dot-pixel-candidate extraction module 130 extracts, as halftone-dot-pixel candidates, halftone-dot pixels that can be candidates.

In step S1206, the screen detection module 140 detects screen information screening that has been performed on a region in the image.

In step S1208, the halftone-dot-pixel extraction module 150 extracts a halftone-dot pixel among the halftone-dot-pixel candidates.

In step S1210, the halftone-dot-pixel adding module 160 adds a halftone dot at a position at which a halftone dot is supposed to exist.

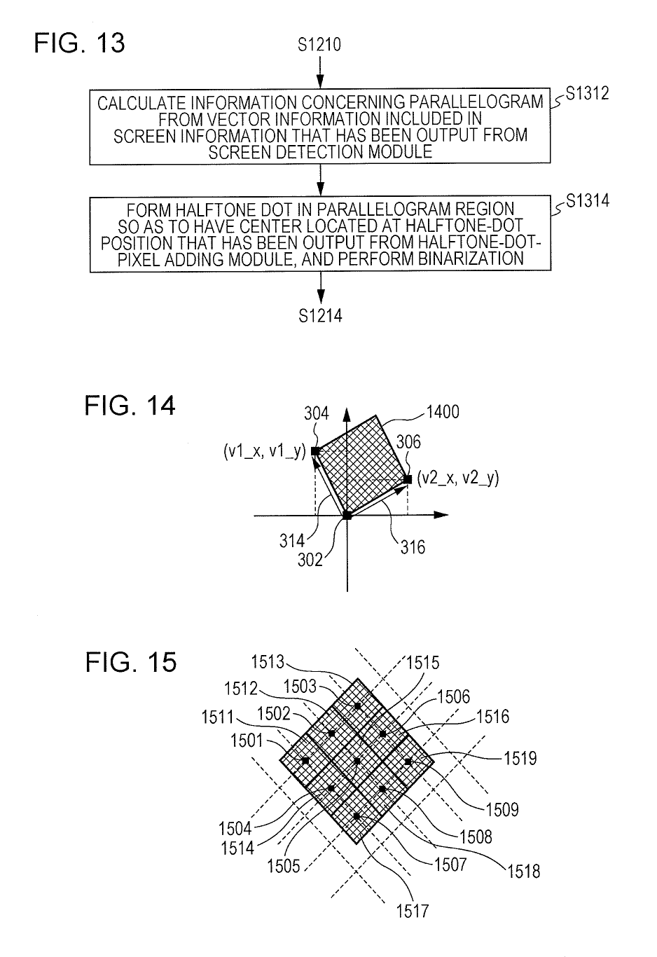

In step S1212, the halftone-dot-region extraction module 1170 performs a process of generating a binary image on the basis of a parallelogram that is formed using screen vectors. This process will be described in detail with reference to FIGS. 13 to 15.

FIG. 13 is a flowchart illustrating an example of the process performed by the halftone-dot-region extraction module 1170.

In step S1312, information concerning a parallelogram is calculated from vector information that is included in the screen information which has been output from the screen detection module 140. FIG. 14 is an explanatory diagram illustrating an example of the process performed by the halftone-dot-region extraction module 1170. The parallelogram is a parallelogram region 1400 that have the screen vectors 314 and 316 as two sides.

In step S1314, a halftone dot is formed in the parallelogram region so as to have a center located at a halftone-dot position that has been output from the halftone-dot-pixel adding module 160, and binarization is performed.

FIG. 15 is an explanatory diagram illustrating an example of the process performed by the halftone-dot-region extraction module 1170. The parallelogram regions 1400 (parallelogram regions 1511 to 1519) that have been generated in step S1312 are combined with one another so that halftone dots will have centers located at positions at which halftone dots have been extracted by the halftone-dot-pixel extraction module 150 and at positions at which halftone dots have been added by the halftone-dot-pixel adding module 160 (halftone-dot positions 1501 to 1509). A region that has been subjected to screening is filled with the parallelogram regions to obtain a result. This result is an example illustrated in FIG. 15. Then, a halftone dot is formed in each of the parallelogram regions, and a binary image is generated.

In step S1214, the output module 180 outputs the binary image that is obtained by converting, using the above-described process, a region which has been subjected to at least screening.

### Third Exemplary Embodiment

FIG. 11 is a module-configuration diagram schematically illustrating an example of a configuration of an image processing apparatus according to a third exemplary embodiment.

The image processing apparatus according to the third exemplary embodiment outputs, as a multiple-value image, an image of a region that has been subjected to at least screening. As shown in the example illustrated in FIG. 11, the image processing apparatus according to the third exemplary embodiment includes the image receiving module 110, the parameter setting module 120, the halftone-dot-pixel-candidate extraction module 130, the screen detection module 140, the halftone-dot-pixel extraction module 150, the halftone-dot-pixel adding module 160, a halftone-dot-region extraction module 1170, and the output module 180.

The information processing apparatus according to the third exemplary embodiment has a configuration that is similar to the configuration of the information processing apparatus according to the second exemplary embodiment. The halftone-dot-region extraction module 1170 receives, from the screen detection module 140, screen information concerning screening that has been performed on an image received by the image receiving module 110. The halftone-dot-region extraction module 1170 generates, on the basis of the screen information and a result of the processes performed by the halftone-dot-pixel extraction module 150 and the halftone-dot-pixel adding module 160, a multiple-value image of a region that has been subjected to screening in the image received by the image receiving module 110.

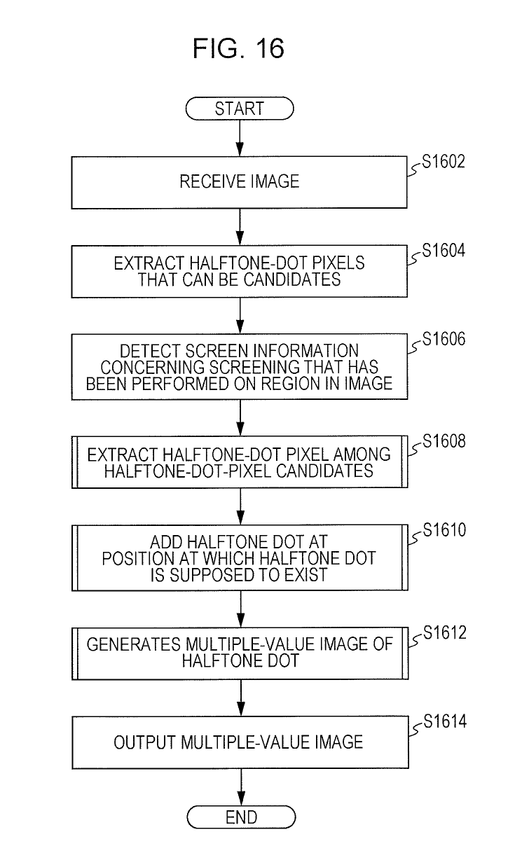

FIG. 16 is a flowchart illustrating an example of a process in the third exemplary embodiment.

In step S1602, the image receiving module 110 receives an image.

In step S1604, the halftone-dot-pixel-candidate extraction module 130 extracts, as halftone-dot-pixel candidates, halftone-dot pixels that can be candidates.

In step S1606, the screen detection module 140 detects screen information screening that has been performed on a region in the image.

In step S1608, the halftone-dot-pixel extraction module 150 extracts a halftone-dot pixel among the halftone-dot-pixel candidates.

In step S1610, the halftone-dot-pixel adding module 160 adds a halftone dot at a position at which a halftone dot is supposed to exist.

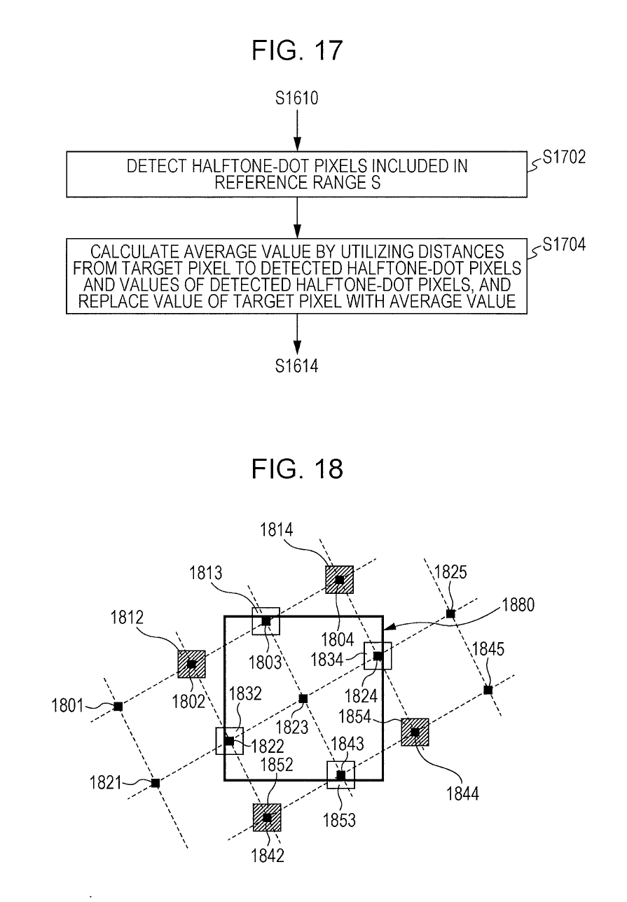

In step S1612, the halftone-dot-region extraction module 1170 performs a process of generating a multiple-value image of a halftone dot. This process will be described in detail with reference to FIGS. 17 to 20.

FIG. 17 is a flowchart illustrating an example of the process performed by the halftone-dot-region extraction module 1170. FIG. 18 is an explanatory diagram illustrating an example of the process performed by the halftone-dot-region extraction module 1170.

In step S1702, halftone-dot pixels included in a reference range S1880 are detected. For example, the reference range S1880 is a rectangular region that has a center located at a halftone-dot position 1823 and that includes a range that is formed using the screen vectors 314 and 316. How far the reference range S1880 extends so as to include halftone-dot positions is determined in accordance with a parameter that has been set by the parameter setting module 120. In the example illustrated in FIG. 18, halftone-dot positions 1803, 1824, 1843, and 1822 are detected as halftone-dot positions that are included in the reference range S1880.

In step S1704, an average value is calculated by utilizing distances from a target pixel to the detected halftone-dot pixels and values of the detected halftone-dot pixels, and the value of the target pixel is replaced with the average value.

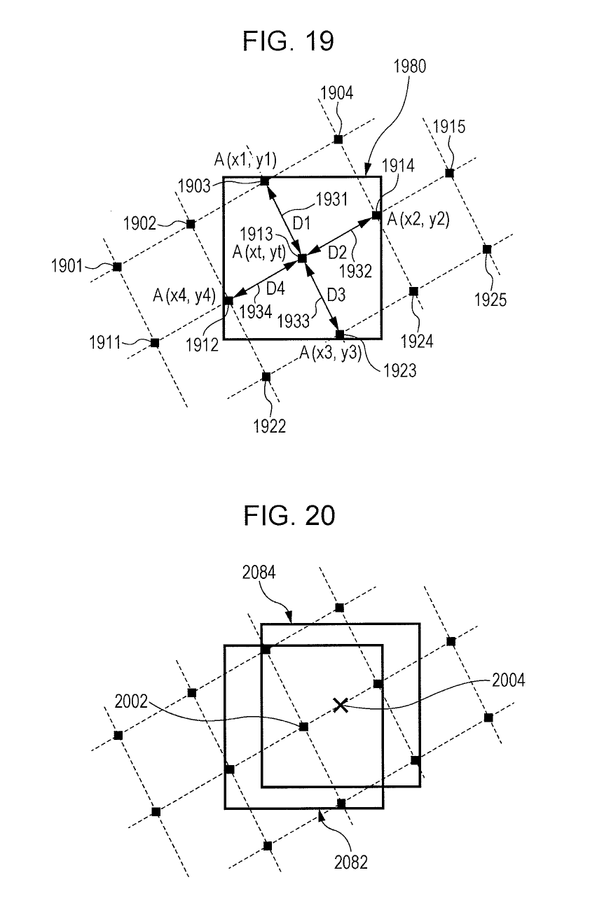

The process performed by the halftone-dot-region extraction module 1170 will be described in detail with reference to FIG. 19. FIG. 19 is an explanatory diagram illustrating an example of the process performed by the halftone-dot-region extraction module 1170. FIG. 19 is equivalent to FIG. 18. However, in FIG. 19, an example is illustrated, in which a reference range S1980 is a rectangular region that has a center located at a halftone-dot position 1913 (A (xt, yt)), and that includes a vector 1931, which is the screen vector 314, a vector 1932, which is the screen vector 316, a vector 1933, which is the reciprocal vector of the screen vector 314, and a vector 1934, which is the reciprocal vector of the screen vector 316.

The value of a pixel that has been subjected to the processes by the halftone-dot-pixel extraction module 150 and the halftone-dot-pixel adding module 160 is denoted by A (x, y). When this pixel is a black pixel, an equation A (x, y)=1.0 is established, and, when this pixel is a white pixel, an equation A (x, y)=0.0 is established. When N pixels that satisfy a relationship A (x, y)>0 exist in the reference range S1980, the position of each of the N pixels is denoted by (xn, yn) (n=1, N). The position of a target pixel is denoted by (xt, yt). A distance from the target pixel A (xt, yt) to the pixel A (xn, yn) is denoted by Dn. When the average value of the pixels included in a halftone-dot region is denoted by A′ (xt, yt), the average value A′ (xt, yt) is calculated using Equation (1).

A′(xt,yt)=(ΣA(xn,yn)/Dn)/N (1)

Equation (1) is provided as a calculation formula in which a high priority is assigned to close pixels (in which an influence of close pixels is increased).

FIG. 20 is an explanatory diagram illustrating an example of the process performed by the halftone-dot-region extraction module 1170. A halftone dot exists at a halftone-dot position 2002. Multiple halftone dots exist in a reference range S2082 that is formed so as to have a center located at the halftone-dot position 2002. Even in a case in which a target pixel is a pixel having no value (for example, a halftone-dot position 2004), if halftone dots exist around the target pixel, one or more halftone dots may be included in a reference range S2084 that is formed so as to have a center located at the halftone-dot position 2004. In this case, a pixel having a value also exists at the halftone-dot position 2004.

In step S1614, the output module 180 outputs a multiple-value image that is obtained by converting, using the above-described process, a region which has been subjected to at least screening. Another region may be also converted into a multiple-value image.

### Fourth Exemplary Embodiment

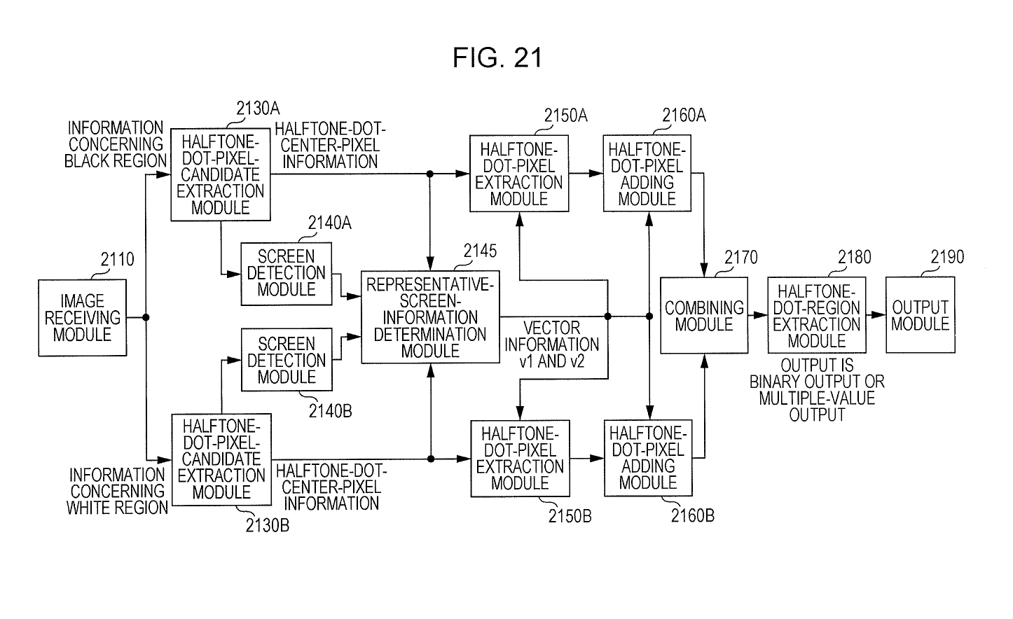

FIG. 21 is a module-configuration diagram schematically illustrating an example of a configuration of an image processing apparatus according to a fourth exemplary embodiment.

The image processing apparatus according to the fourth exemplary embodiment performs a process associated with halftone dots of an image so that a black region and a white region of the image are separately subjected to the process. The image processing apparatus according to the fourth exemplary embodiment includes an image receiving module 2110, halftone-dot-pixel-candidate extraction modules 2130A and 2130B, screen detection modules 2140A and 2140B, a representative-screen-information determination module 2145, halftone-dot-pixel extraction modules 2150A and 2150B, halftone-dot-pixel adding modules 2160A and 2160B, a combining module 2170, a halftone-dot-region extraction module 2180, and an output module 2190.

Note that the halftone-dot-pixel-candidate extraction module 2130A, the screen detection module 2140A, the halftone-dot-pixel extraction module 2150A, and the halftone-dot-pixel adding module 2160A are equivalent to the halftone-dot-pixel-candidate extraction module 2130B, the screen detection module 2140B, the halftone-dot-pixel extraction module 2150B, and the halftone-dot-pixel adding module 2160B, respectively. The only difference therebetween is whether a black region is a target region or a white region is a target region.

Furthermore, the halftone-dot-pixel-candidate extraction modules 2130A and 2130B correspond to the halftone-dot-pixel-candidate extraction module 130 which is described above, and perform a process that is equivalent to the process preformed by the halftone-dot-pixel-candidate extraction module 130. The screen detection modules 2140A and 2140B correspond to the screen detection module 140 which is described above, and perform a process that is equivalent to the process preformed by the screen detection module 140. The halftone-dot-pixel extraction modules 2150A and 2150B correspond to the halftone-dot-pixel extraction module 150 which is described above, and perform a process that is equivalent to the process preformed by the halftone-dot-pixel extraction module 150. The halftone-dot-pixel adding modules 2160A and 2160B correspond to the halftone-dot-pixel adding module 160 which is described above, and perform a process that is equivalent to the process preformed by the halftone-dot-pixel adding module 160. A redundant description of these processes is omitted.

Note that, referring to FIG. 21, two modules, such as the halftone-dot-pixel-candidate extraction modules 2130A and 2130B, are provided for each of the processes. However, one module may be provided for each of the processes, and, the process may be performed on a white region after the process performed on a black region has finished. Alternatively, the processes may be performed in a time division manner.

Additionally, although the parameter setting module 120 provided in each of the above-described exemplary embodiments is not illustrated, the parameter setting module 120 may be added in the image processing apparatus according to the fourth exemplary embodiment. For example, the parameter setting module 120 sets parameters that are to be used in the halftone-dot-pixel-candidate extraction module 2130A, the halftone-dot-pixel-candidate extraction module 2130B, the screen detection module 2140A, the screen detection module 2140B, the halftone-dot-pixel extraction module 2150A, the halftone-dot-pixel extraction module 2150B, the halftone-dot-pixel adding module 2160A, and the halftone-dot-pixel adding module 2160B.

The image receiving module 2110 is connected to the halftone-dot-pixel-candidate extraction modules 2130A and 2130B. The image receiving module 2110 passes on an image of a black region to the halftone-dot-pixel-candidate extraction module 2130A, and passes on an image of a white region to the halftone-dot-pixel-candidate extraction module 2130B. The image receiving module 2110 may divide, into two regions, an image received thereby. Alternatively, the image receiving module 2110 may pass on the received image to each of the halftone-dot-pixel-candidate extraction modules 2130A and 2130B. Supposing that the black region is a halftone-dot region, each of the halftone-dot-pixel-candidate extraction module 2130A, the screen detection module 2140A, the halftone-dot-pixel extraction module 2150A, and the halftone-dot-pixel adding module 2160A performs a corresponding one of the processes. Supposing that the white region, instead of the black region, is a halftone-dot region, each of the halftone-dot-pixel-candidate extraction module 2130B, the screen detection module 2140B, the halftone-dot-pixel extraction module 2150B, and the halftone-dot-pixel adding module 2160B performs a corresponding one of the processes. When the received image is divided into two regions, halftone-dot regions are extracted using existing image processing. A lightly colored region (in which the area of black is equal to or smaller than 50% or is smaller than 50% in a region that is determined in advance), i.e., a region in which a halftone is expressed using black halftone dots, is extracted as a black region. A highly colored region (in which the area of white is equal to or smaller than 50% or is smaller than 50% in a region that is determined in advance), i.e., a region in which a halftone is expressed using white halftone dots, is extracted as a white region.

The halftone-dot-pixel-candidate extraction module 2130A is connected to the image receiving module 2110, the screen detection module 2140A, the representative-screen-information determination module 2145, and the halftone-dot-pixel extraction module 2150A.

The halftone-dot-pixel-candidate extraction module 2130B is connected to the image receiving module 2110, the screen detection module 2140B, the representative-screen-information determination module 2145, and the halftone-dot-pixel extraction module 2150B.

The screen detection module 2140A is connected to the halftone-dot-pixel-candidate extraction module 2130A and the representative-screen-information determination module 2145.

The screen detection module 2140B is connected to the halftone-dot-pixel-candidate extraction module 2130B and the representative-screen-information determination module 2145.

The representative-screen-information determination module 2145 is connected to the halftone-dot-pixel-candidate extraction modules 2130A and 2130B, the screen detection modules 2140A and 2140B, the halftone-dot-pixel extraction modules 2150A and 2150B, and the halftone-dot-pixel adding modules 2160A and 2160B. The representative-screen-information determination module 2145 determines, on the basis of screen information screening that has been performed on the black region and on the basis of screen information screening that has been performed on the white region, screen information concerning screening that has been performed on the image received by the image receiving module 2110. For example, screen vectors b_v1 and b_v2 (which correspond to the halftone-dot pixels 304 and 306, respectively, that are illustrated as examples in FIG. 3) are detected as screen information from the black region by the screen detection module 2140A. Screen vectors w_v1 and w_v2 (which correspond to the halftone-dot pixels 304 and 306, respectively, that are illustrated as examples in FIG. 3) are detected as screen information from the white region by the screen detection module 2140B. The representative-screen-information determination module 2145 determines representative screen information using both the screen vectors b_v1 and b_v2 and the screen vectors w_v1 and w_v2. Typically, because the screen vectors b_v1 and b_v2 and screen vectors w_v1 and w_v2 are the same as each other, the screen vectors b_v1 and b_v2 or the screen vectors w_v1 and w_v2 may be employed. Furthermore, when the screen vectors b_v1 and b_v2 and the screen vectors w_v1 and w_v2 are different from each other (for example, when screen information cannot be accurately extracted due to incorrect detection), one of processes given below is performed. For example, a process of employing screen information screening that has been performed on a region from which the number of halftone-dot-pixel candidates that is larger than the number of halftone-dot-pixel candidates extracted from the other region has been extracted may be performed. Alternatively, a process of removing a vector that is certainly unexpected (a process of removing a vector that exists outside a region which is determined in advance) is performed. Alternatively, a process of employing a vector between the screen vectors b_v1 and w_v1 and a vector between the screen vectors b_v2 and w_v2 is performed.

The halftone-dot-pixel extraction module 2150A is connected to the halftone-dot-pixel-candidate extraction module 2130A, the representative-screen-information determination module 2145, and the halftone-dot-pixel adding module 2160A.

The halftone-dot-pixel extraction module 2150B is connected to the halftone-dot-pixel-candidate extraction module 2130B, the representative-screen-information determination module 2145, and the halftone-dot-pixel adding module 2160B.

The halftone-dot-pixel adding module 2160A is connected to the representative-screen-information determination module 2145, the halftone-dot-pixel extraction module 2150A, and the combining module 2170.

The halftone-dot-pixel adding module 2160B is connected to the representative-screen-information determination module 2145, the halftone-dot-pixel extraction module 2150B, and the combining module 2170.

The halftone-dot-pixel extraction modules 2150A and 2150B, and the halftone-dot-pixel adding modules 2160A and 2160B perform the processes on the basis of the representative screen information that has been determined by the representative-screen-information determination module 2145.

The combining module 2170 is connected to the halftone-dot-pixel adding modules 2160A and 2160B, and the halftone-dot-region extraction module 2180. The combining module 2170 combines a result of the processes that have been performed by the halftone-dot-pixel extraction module 2150A and the halftone-dot-pixel adding module 2160A on the black region and a result of the processes that have been performed by the halftone-dot-pixel extraction module 2150B and the halftone-dot-pixel adding module 2160B on the white region with each other. The combining module 2170 performs a logical OR operation as a combining process.

The halftone-dot-region extraction module 2180 is connected to the combining module 2170 and the output module 2190. The halftone-dot-region extraction module 2180 performs a process that is equivalent to the process performed by the separation-signal generating module 170 in the first exemplary embodiment or to the process performed by the halftone-dot-region extraction module 1170 in the second or third exemplary embodiment.

The output module 2190 is connected to the halftone-dot-region extraction module 2180. The output module 2190 performs a process that is equivalent to the process performed by the output module 180 which is described above.

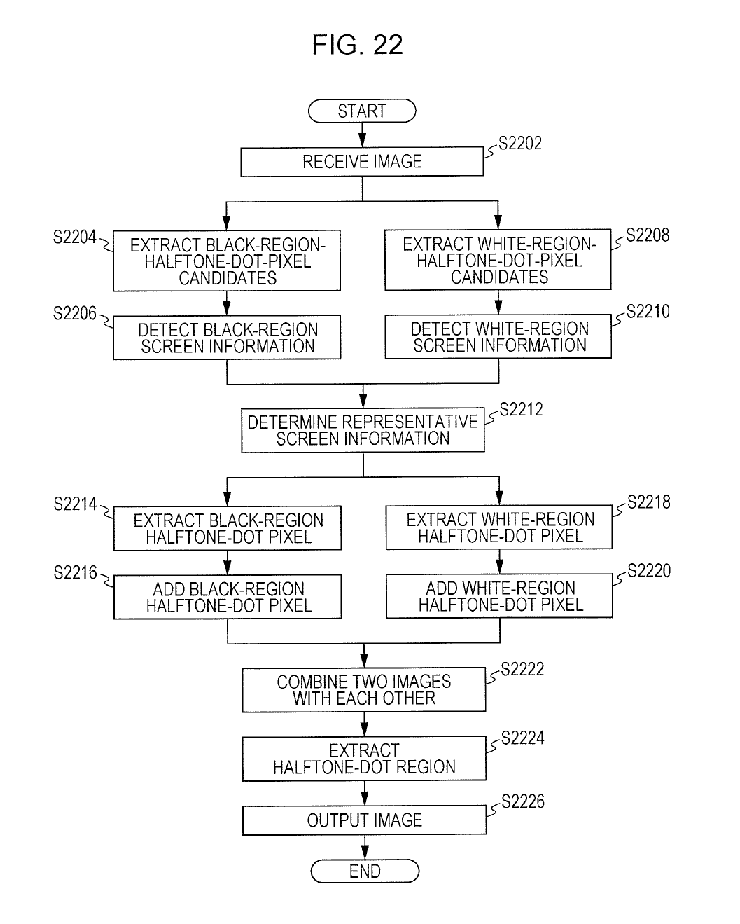

FIG. 22 is a flowchart illustrating an example of a process in the fourth exemplary embodiment.

In step S2202, the image receiving module 2110 receives an image.

In step S2204, the halftone-dot-pixel-candidate extraction module 2130A extracts black-region-halftone-dot-pixel candidates.

In step S2206, the screen detection module 2140A detects black-region screen information.

In step S2208, the halftone-dot-pixel-candidate extraction module 2130B extracts white-region-halftone-dot-pixel candidates.

In step S2210, the screen detection module 2140B detects white-region screen information.

In step S2212, the representative-screen-information determination module 2145 determines representative screen information.

In step S2214, the halftone-dot-pixel extraction module 2150A extracts a black-region halftone-dot pixel.

In step S2216, the halftone-dot-pixel extraction module 2160A adds a black-region halftone-dot pixel.

In step S2218, the halftone-dot-pixel extraction module 2150B extracts a white-region halftone-dot pixel.

In step S2220, the halftone-dot-pixel extraction module 2160B adds a white-region halftone-dot pixel.

In step S2222, the combining module 2170 combines two images (results of the processes performed in steps S2216 and S2220) with each other.

In step S2224, the halftone-dot-region extraction module 2180 extracts a halftone-dot region.

In step S2226, the output module 2190 outputs an image.

### Fifth Exemplary Embodiment

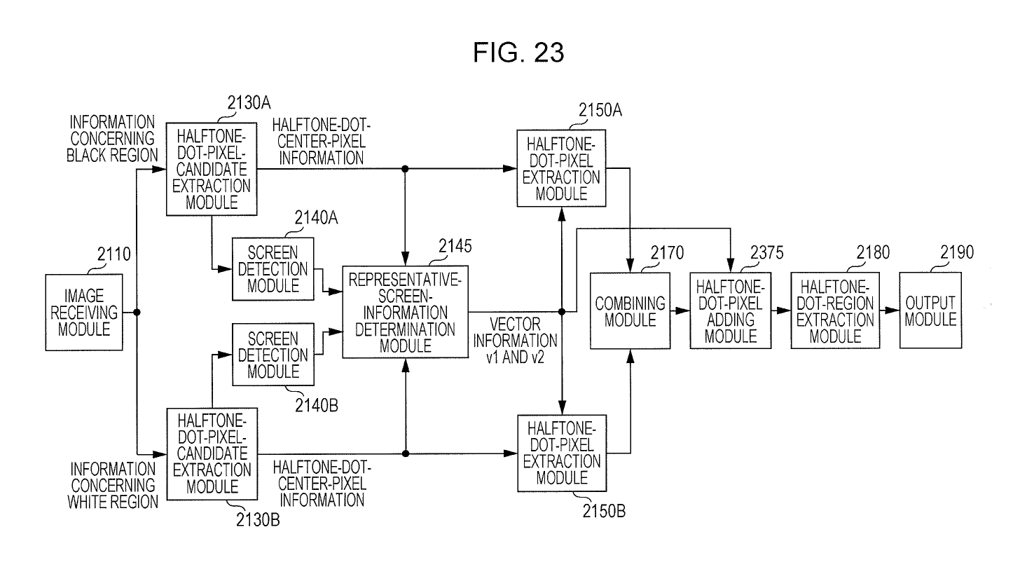

FIG. 23 is a module-configuration diagram schematically illustrating an example of a configuration of an image processing apparatus according to a fifth exemplary embodiment.

The image processing apparatus according to the fifth exemplary embodiment performs a process associated with halftone dots of an image so that a black region and a white region of the image are separately subjected to the process. The image processing apparatus according to the fourth exemplary embodiment includes an image receiving module 2110, halftone-dot-pixel-candidate extraction modules 2130A and 2130B, screen detection modules 2140A and 2140B, a representative-screen-information determination module 2145, halftone-dot-pixel extraction modules 2150A and 2150B, a combining module 2170, a halftone-dot-pixel adding module 2375, a halftone-dot-region extraction module 2180, and an output module 2190. Note that, hereinafter, elements whose types are the same as the types of the elements in the fourth exemplary embodiment are denoted by the same reference numerals, and a redundant description is omitted.

Note that the halftone-dot-pixel-candidate extraction module 2130A, the screen detection module 2140A, and the halftone-dot-pixel extraction module 2150A are equivalent to the halftone-dot-pixel-candidate extraction module 2130B, the screen detection module 2140B, and the halftone-dot-pixel extraction module 2150B, respectively. The only difference therebetween is whether a black region is a target region or a white region is a target region.

Furthermore, the halftone-dot-pixel-candidate extraction modules 2130A and 2130B correspond to the halftone-dot-pixel-candidate extraction module 130 which is described above, and perform a process that is equivalent to the process preformed by the halftone-dot-pixel-candidate extraction module 130. The screen detection modules 2140A and 2140B correspond to the screen detection module 140 which is described above, and perform a process that is equivalent to the process preformed by the screen detection module 140. The halftone-dot-pixel extraction modules 2150A and 2150B correspond to the halftone-dot-pixel extraction module 150 which is described above, and perform a process that is equivalent to the process preformed by the halftone-dot-pixel extraction module 150. The halftone-dot-pixel adding module 2375 corresponds to the halftone-dot-pixel adding module 160 which is described above, and performs a process that is equivalent to the process preformed by the halftone-dot-pixel adding module 160. A redundant description of these processes is omitted.

Note that, in the example illustrated in FIG. 23, two modules, such as the halftone-dot-pixel-candidate extraction modules 2130A and 2130B, are provided for each of the processes. However, one module may be provided for each of the processes, and, the process may be performed on a white region after the process performed on a black region has finished. Alternatively, the processes may be performed in a time division manner.

Additionally, although the parameter setting module 120 provided in each of the above-described exemplary embodiments is not illustrated, the parameter setting module 120 may be added in the image processing apparatus according to the fifth exemplary embodiment. For example, the parameter setting module 120 sets parameters that are to be used in the halftone-dot-pixel-candidate extraction module 2130A, the halftone-dot-pixel-candidate extraction module 2130B, the screen detection module 2140A, the screen detection module 2140B, the halftone-dot-pixel extraction module 2150A, the halftone-dot-pixel extraction module 2150B, and the halftone-dot-pixel adding module 2375.

Supposing that the black region is a halftone-dot region, each of the halftone-dot-pixel-candidate extraction module 2130A, the screen detection module 2140A, and the halftone-dot-pixel extraction module 2150A performs a corresponding one of the processes. Supposing that the white region, instead of the black region, is a halftone-dot region, each of the halftone-dot-pixel-candidate extraction module 2130B, the screen detection module 2140B, and the halftone-dot-pixel extraction module 2150B performs a corresponding one of the processes.

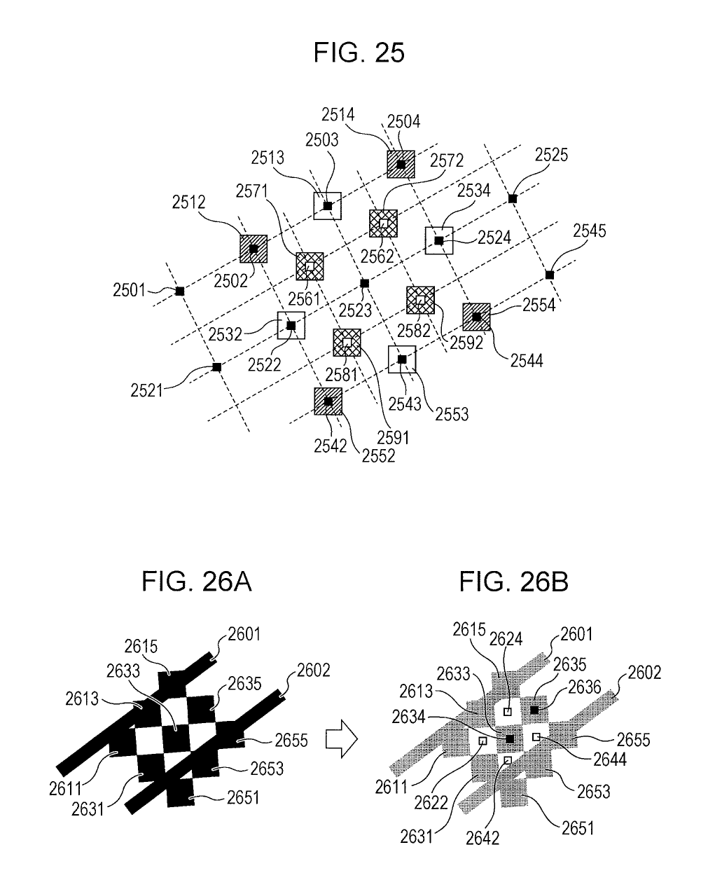

The halftone-dot-pixel extraction module 2150A is connected to the halftone-dot-pixel-candidate extraction module 2130A, the representative-screen-information determination module 2145, and the combining module 2170. The halftone-dot-pixel extraction module 2150A performs a process that is equivalent to the process performed by the halftone-dot-pixel extraction module 2150A in the fourth exemplary embodiment. Note that the halftone-dot-pixel extraction module 2150A performs the process on the basis of representative screen information that has been determined by the representative-screen-information determination module 2145. Then, the halftone-dot-pixel extraction module 2150A passes on a result of the process to the combining module 2170. Furthermore, the halftone-dot-pixel extraction module 2150A may perform a process that is described below with reference to FIG. 25 and FIGS. 26A and 26B.

The halftone-dot-pixel extraction module 2150B is connected to the halftone-dot-pixel-candidate extraction module 2130B, the representative-screen-information determination module 2145, and the combining module 2170. The halftone-dot-pixel extraction module 2150B performs a process that is equivalent to the process performed by the halftone-dot-pixel extraction module 2150B in the fourth exemplary embodiment. Note that the halftone-dot-pixel extraction module 2150B performs the process on the basis of the representative screen information that has been determined by the representative-screen-information determination module 2145. Then, the halftone-dot-pixel extraction module 2150B passes on a result of the process to the combining module 2170.

The combining module 2170 is connected to the halftone-dot-pixel extraction modules 2150A and 2150B, and the halftone-dot-pixel adding module 2375. The combining module 2170 combines a result of the process that has been performed by the halftone-dot-pixel extraction module 2150A on the black region and a result of the process that has been performed by the halftone-dot-pixel extraction module 2150B on the white region with each other. Then, the combining module 2170 passes on a result of the process performed thereby to the halftone-dot-pixel adding module 2375.

The halftone-dot-pixel adding module 2375 is connected to the representative-screen-information determination module 2145, the combining module 2170, and the halftone-dot-region extraction module 2180. The halftone-dot-pixel adding module 2375 adds, on the basis of the representative screen information that has been determined by the representative-screen-information determination module 2145, for the result of the process performed by the combining module 2170, halftone dots at positions of pixel blocks that have not been extracted by the halftone-dot-pixel-candidate extraction modules 2130A and 2130B.

The halftone-dot-region extraction module 2180 is connected to the halftone-dot-pixel adding module 2375 and the output module 2190. The halftone-dot-region extraction module 2180 performs a process that is equivalent to the process performed by the halftone-dot-region extraction module 2180 in the fourth exemplary embodiment.

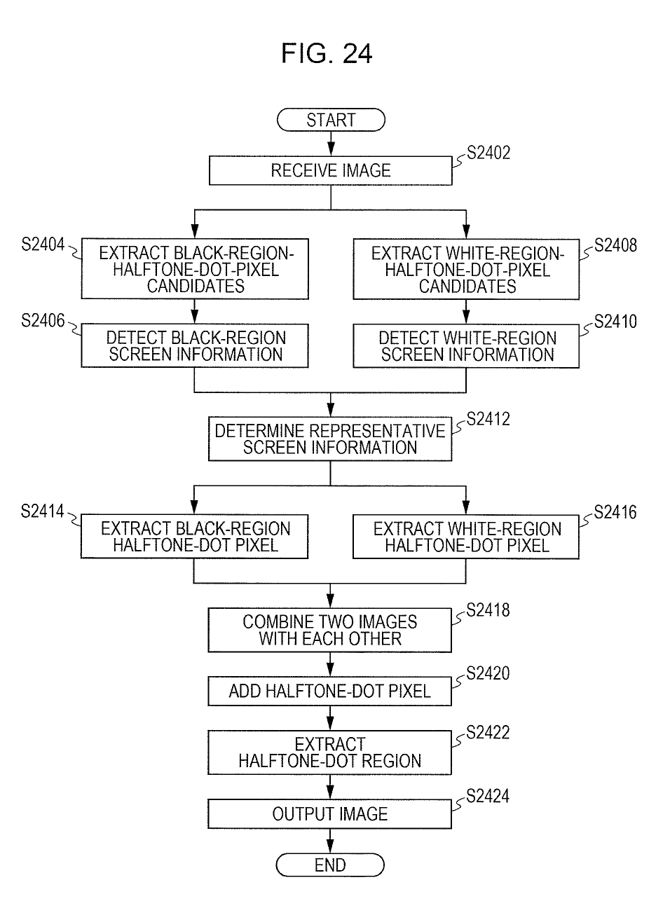

FIG. 24 is a flowchart illustrating an example of a process in the fifth exemplary embodiment.

In step S2402, the image receiving module 2110 receives an image.

In step S2404, the halftone-dot-pixel-candidate extraction module 2130A extracts black-region-halftone-dot-pixel candidates.

In step S2406, the screen detection module 2140A detects black-region screen information.

In step S2408, the halftone-dot-pixel-candidate extraction module 2130B extracts white-region-halftone-dot-pixel candidates.

In step S2410, the screen detection module 2140B detects white-region screen information.

In step S2412, the representative-screen-information determination module 2145 determines representative screen information.

In step S2414, the halftone-dot-pixel extraction module 2150A extracts a black-region halftone-dot pixel.

In step S2416, the halftone-dot-pixel extraction module 2150B extracts a white-region halftone-dot pixel.

In step S2418, the combining module 2170 combines two images (results of the processes performed in steps S2414 and S2416) with each other.

In step S2420, the halftone-dot-pixel adding module 2375 adds a halftone-dot pixel. Even in an image that is obtained by combining two images with each other in step S2418, because reference ranges are set using screen vectors, when a target halftone dot is a black halftone dot, black pixels are referred to, and, when a target halftone dot is a white halftone dot, white pixels are referred to.

In step S2422, the halftone-dot-region extraction module 2180 extracts a halftone-dot region.

In step S2424, the output module 2190 outputs an image.

The halftone-dot-pixel extraction modules 2150A and 2150B may determine, using criteria based on the number of pixel blocks that exist around a target position, and that have a color different from the color of a pixel block which exists at the target position, whether or not a halftone dot is supposed to exist at the target position. In the description given below, a case in which the color of a pixel block that exists at the target position is black, and in which a color different from the color is white is described as an example. As a matter of course, the color of a pixel block that exists at the target position may be white, and a color different from the color may be black.

FIG. 25 is an explanatory diagram illustrating an example of a process performed on a black region by the halftone-dot-pixel extraction module 2150A. Note that, for the halftone-dot-pixel extraction module 2150B, swapping between black and white may be performed (black halftone dots and white halftone dots are swapped).

In the example illustrated in FIG. 25, halftone-dot positions (2561, 2562, 2581, and 2582) that are associated with a group 3 and reference ranges I to L (2571, 2572, 2592, and 2591) that are grouped into the group 3 are added to the example illustrated in FIG. 5. Note that elements that are the same as the elements denoted by reference numerals in the 500's in the example illustrated in FIG. 5 are denoted by reference numeral in the 2500's in the example illustrated in FIG. 25, and a redundant description thereof is omitted. For example, the halftone-dot position 523 in the example illustrated in FIG. 5 corresponds to the halftone-dot position 2523 in the example illustrated in FIG. 25.

In the above-described exemplary embodiments (the first to fourth exemplary embodiments), whether or not the target pixel is a halftone-dot pixel is determined on the basis of the number of flags of the group 1 and the number of flags of the group 2. A condition using the number of flags of the reference ranges (the group 3) that include halftone-dot pixels having a color different from the color of the target pixel is added as a condition of the determination. The halftone-dot positions (2561, 2562, 2581, and 2582) are positions that are relatively defined by the screen vectors 314 and 316 using the halftone-dot position 2523 as a base point.

In a case in which black pixels exist at the halftone-dot position 2523 that is a target halftone-dot position and halftone-dot positions (halftone-dot positions 2502, 2504, 2544, and 2542 included in the group 2) that exist around the halftone-dot position 2523, white halftone dots (at halftone-dot positions 2561, 2562, 2582, and 2581) are also supposed to exist between the halftone-dot position 2523 and the halftone-dot positions (the halftone-dot positions 2502, 2504, 2544, and 2542) that exist around the halftone-dot position 2523. For this reason, also for the white halftone dots, as in the case of black halftone dots, the number of white halftone-dot pixels are calculated in each of the reference ranges (the reference ranges I2571, J2572, K2592, and L2591 being grouped into the group 3) that are determined in advance. Regarding to each of the reference ranges, when the number of white halftone-dot pixels included in the reference range is equal to or larger than one, a flag is set for the reference range. A condition using the number of flags of the group 3 is added as a condition of the determination.

For example, a condition is added, and the condition is a condition where, even in a case in which the determination described with reference to FIGS. 4 to 6 is performed and in which it is determined that the target pixel is not a halftone dot as a result, when the number of flags of the group 3 is equal to or larger than two, it is determined that the target pixel is a halftone dot.

The reference range I2571 indicates a region that includes the halftone-dot position 2561, and that is located at an intermediate position between the halftone-dot positions 2523 and 2502.

The reference range J2572 indicates a region that includes the halftone-dot position 2562, and that is located at an intermediate position between the halftone-dot positions 2523 and 2504.

The reference range K2592 indicates a region that includes the halftone-dot position 2582, and that is located at an intermediate position between the halftone-dot positions 2523 and 2544.

The reference range L2591 indicates a region that includes the halftone-dot position 2581, and that is located at an intermediate position between the halftone-dot positions 2523 and 2542.

FIGS. 26A and 26B are explanatory diagrams illustrating an example of the process that is performed on a black region in a case in which halftone dots are in contact with straight lines.

For example, in a case in which halftone dots are in contact with straight lines because of a reason associated with a screen ruling or a screen angle, even when black halftone-dot-pixel candidates are not obtained, whether or not the target pixel is a halftone dot is determined by utilizing white halftone-dot-pixel candidates that are adjacent to the black halftone-dot-pixel candidates. For example, as illustrated in FIG. 26A, a straight line 2601 is in contact with black halftone dots (2611, 2613, and 2615), and a straight line 2602 is in contact with black halftone dots (2631, 2651, 2653, and 2655). Accordingly, the halftone-dot-pixel-candidate extraction module (130 or 2130A) extracts only a halftone-dot position 2634 and a halftone-dot position 2636 as a halftone-dot-pixel candidate for a black halftone dot 2633 and a halftone-dot-pixel candidate for a black halftone dot 2635, respectively, as illustrated in FIG. 26B. Note that, in the example illustrated in FIG. 26B, elements shown in the example illustrated in FIG. 26A are filled in gray.

The halftone-dot-pixel extraction module 2150A extracts white-halftone-dot positions 2622, 2624, 2644, and 2642 using the halftone-dot position 2634, which is a target halftone-dot position, and the screen vectors 314 and 316. In other words, using the halftone-dot position 2634, which is a target halftone-dot position, and the screen vectors 314 and 316, the halftone-dot-pixel extraction module 2150A extracts the white-halftone-dot positions 2622, 2624, 2644, and 2642 that are located at intermediate positions between the halftone-dot position 2634 and the black-halftone-dot positions (the center of the halftone dot 2611, the center of the halftone dot 2615, the center of the halftone dot 2655, and the center of the halftone dot 2651) of the group 2. Then, the number of white halftone-dot pixels is calculated in each of the reference ranges (the reference ranges I2571, J2572, K2592, and L2591 in the example illustrated in FIG. 25) that are formed so as to have centers located at the halftone-dot positions. Regarding to each of the reference ranges, when the number of white halftone-dot pixels included in the reference range is equal to or larger than one, a flag is set for the reference range. A condition using the number of flags of the group 3 is added as a condition of the determination.

Accordingly, when the determination described with reference to FIG. 4 is performed, in step S404, it is determined that the target pixel is not a halftone dot. However, after that, the halftone-dot-pixel extraction module 2150A calculates the number of white halftone-dot pixels that are included in each of the reference ranges (the reference ranges I2571, J2572, K2592, and L2591 in the example illustrated in FIG. 25) that are formed so as to have centers located at the white-halftone-dot positions 2622, 2624, 2644, and 2642. Regarding each of the reference ranges, because the number of white halftone-dot pixels included in the reference range is equal to or larger than one, a flag is set for the reference range. Accordingly, the number of flags of the group 3 is four, and it is determined that the target pixel is a halftone dot. Because it is determined that the target pixel is a halftone dot, in step S406, the halftone-dot position 2634 of the target pixel is left as a position of a halftone dot.

Note that the process that is described with reference to FIG. 25 and FIGS. 26A and 26B and that is performed by the halftone-dot-pixel extraction module 2150A may be applied to the halftone-dot-pixel extraction modules in the above-described exemplary embodiments (the first to fourth exemplary embodiments). Furthermore, although the group 2 is used to calculate halftone-dot positions included in the group 3 in this example, the group 1 may be used.

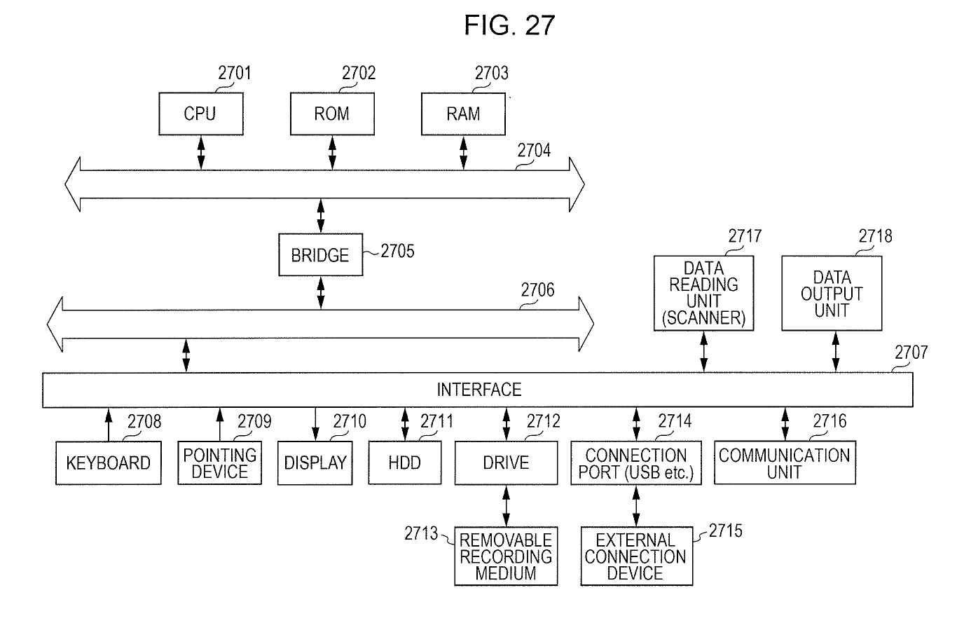

An example of a hardware configuration of an image processing apparatus according to a present exemplary embodiment will be described with reference to FIG. 27. The configuration illustrated in FIG. 27 is a hardware configuration of an image processing apparatus that is configured so as to include, for example, a personal computer (PC), and that further includes a data reading unit 2717, such as a scanner, and a data output unit 2718, such as a printer.

A CPU 2701 is a controller that performs a process in accordance with a computer program. In the computer program, execution sequences of the various modules that are described in the foregoing exemplary embodiments, i.e., the individual modules such as the halftone-dot-pixel-candidate extraction module 130, the screen detection module 140, the halftone-dot-pixel extraction module 150, the halftone-dot-pixel adding module 160, the separation-signal generating module 170, the halftone-dot-region extraction module 1170, the representative-screen-information determination module 2145, the combining module 2170, and the halftone-dot-pixel adding module 2375, are described.

A read only memory (ROM) 2702 stores a program, arithmetic operation parameters, and so forth that are used by the CPU 2701. A RAM 2703 stores a program that is used for execution of the CPU 2701, parameters that change as appropriate during the execution, and so forth. The CPU 2701, the ROM 2702, and the RAM 2703 are connected to each other via a host bus 2704 that includes a CPU bus and so forth.

The host bus 2704 is connected to an external bus 2706 such as a Peripheral Component Interconnect/Interface (PCI) bus via a bridge 2705.

A keyboard 2708 and a pointing device 2709, such as a mouse, are input devices operated by an operator. A display 2710 is a liquid crystal display device, a cathode ray tube (CRT) display, or the like, and displays various information as text or image information.

A hard disk drive (HDD) 2711 has a built-in hard disk, and drives the hard disk to cause the hard disk to record or reproduce a program to be executed by the CPU 2701 or information. In the hard disk, a target image, screen information concerning screening, results of the processes performed by the individual modules, and so forth are stored. Furthermore, various computer programs such as other various data processing programs are stored.

A removable recording medium 2713 such as a magnetic disk, an optical disk, a magneto-optical disk, or a semiconductor memory is mounted in the drive 2712. The drive 2712 reads data or a program that is recorded on the removable recording medium 2713, and supplies the data or program to the RAM 2703 that is connected via the interface 2707, the external bus 2706, the bridge 2705, and the host bus 2704. The removable recording medium 2713 may also be utilized as a data recording region that is similar to the hard disk.

A connection port 2714 is a port to which an external connection device 2715 is connected, and has connection units such as a universal serial bus (USB) and an Institute of Electrical and Electronic Engineers (IEEE) 1394 connection unit. The connection port 2714 is connected to the CPU 2701 and so forth via the interface 2707, the external bus 2706, the bridge 2705, the host bus 2704, and so forth. A communication unit 2716 is connected to a network, and performs a process of performing data communication with an external device. The data reading unit 2717 is, for example, a scanner, and performs a process of reading a document. The data output unit 2718 is, for example, a printer, and performs a process of outputting document data.

Note that the hardware configuration of the image processing apparatus illustrated in FIG. 27 is one example of a configuration. The hardware configuration in the present exemplary embodiment is not limited to the hardware configuration illustrated in FIG. 27. The hardware configuration may be a configuration in which the modules that are described in the present exemplary embodiment can be executed. For example, some modules may be configured using dedicated hardware (for example, an application specific integrated circuit (ASIC)). A configuration in which some modules are provided in an external system and connected via a communication line may be used. Furthermore, multiple systems, each of which has the hardware configuration illustrated in FIG. 27, may be connected to each other via a communication line, and may operate in collaboration with each other. Moreover, a system having the hardware configuration illustrated in FIG. 27 may be incorporated in a copier, a facsimile machine, a scanner, a printer, a multifunctional machine (an image processing apparatus having at least two functions among a scanner function, a printer function, a copier function, a facsimile function, and so forth), or the like.

Note that combinations of the above-described exemplary embodiments may be used (for example, a module in one of the exemplary embodiments is added to another one of the exemplary embodiments, or a module in one of the exemplary embodiments is replaced with a module in another one of the exemplary embodiments). Any described technique of the related art may be employed as the contents of the processes performed by the individual modules.

Note that the above-described program may be stored on a recording medium, and may be supplied. Furthermore, the program may be supplied using a communication unit. In such a case, for example, regarding the above-described program, it may be considered that a “computer readable recording medium storing a program” is provided as an invention.

The “computer readable recording medium storing a program” is a recording medium which is used to install a program, to execute a program, to distribute a program, or the like, in which a program is stored, and which can be read by a computer.

Note that examples of the recording medium include the following: digital versatile discs (DVDs) including “a DVD-recordable(R), a DVD-rewritable(RW), a DVD-RAM, and so forth”, which are standards established by the DVD forum, and including “a DVD+R, a DVD+RW, and so forth” which are standards established by the DVD+RW Alliance; compact discs (CDs) including a CD-ROM, a CD-R, a CD-RW, and so forth; a Blu-ray Disc (registered trademark); a magneto-optical disk (MO); a flexible disk (FD); a magnetic tape; an HD; a ROM; an electrically erasable programmable read-only memory (EEPROM (registered trademark)); a flash memory; and a RAM.

Additionally, the above-described program or one portion thereof may be recorded on the recording medium, and may be stored, distributed, or the like. Furthermore, the above-described program may be transmitted by communication using a transmission medium such as a wired network, a wireless communication network, or a combination of a wired network and a wireless communication network. The transmission medium is used, for example, in the following: a local area network (LAN); a metropolitan area network (MAN); a wide area network (WAN); the Internet; an intranet; and an extranet. Moreover, the above-described program may be transported by being superimposed on a carrier wave.

In addition, the above-described program may be one portion of another program. Alternatively, the above-described program may be recorded on a recording medium together with another program. Furthermore, the above-described program may be divided into programs, and the programs may be recorded on multiple recording media. Moreover, the above-described program may be recorded in any manner, such as compression or encryption, if the above-described program that has been recorded can be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an image receiving unit that receives an image;
a screen-information receiving unit that receives screen information concerning screening which has been performed on the image received by the image receiving unit, thereby performing a screen-information reception process;
a pixel-block extraction unit that extracts pixel blocks which are possibly halftone dots included in the image received by the image receiving unit, thereby performing a pixel-block extraction process;
a halftone-dot extraction unit that extracts, on the basis of the screen information received by the screen-information receiving unit, a pixel block which is a halftone dot among the pixel blocks extracted by the pixel-block extraction unit, thereby performing a halftone-dot extraction process; and
a halftone-dot adding unit that adds, on the basis of the screen information received by the screen-information receiving unit, a halftone dot at a position at which no pixel block has been extracted by the pixel-block extraction unit, thereby performing a halftone-dot addition process.

2. The image processing apparatus according to claim 1,
wherein the halftone-dot extraction unit and the halftone-dot adding unit determine, using criteria based on the number of pixel blocks that exist around a target position, whether or not a halftone dot is supposed to exist at the target position, and
wherein the criteria used by the halftone-dot extraction unit and the halftone-dot adding unit are different from each other.

3. The image processing apparatus according to claim 1, further comprising
a separation-signal generating unit that generates, on the basis of a result of the halftone-dot extraction process and the halftone-dot addition process performed by the halftone-dot extraction unit and the halftone-dot adding unit, respectively, a signal which enables a region that has been subjected to screening in the image received by the image receiving unit to be separated.

4. The image processing apparatus according to claim 2, further comprising
a separation-signal generating unit that generates, on the basis of a result of the halftone-dot extraction process and the halftone-dot addition process performed by the halftone-dot extraction unit and the halftone-dot adding unit, respectively, a signal which enables a region that has been subjected to screening in the image received by the image receiving unit to be separated.

5. The image processing apparatus according to claim 1, further comprising
a binary-image generating unit that generates, on the basis of the screen information received by the screen-information receiving unit and a result of the halftone-dot extraction process and the halftone-dot addition process performed by the halftone-dot extraction unit and the halftone-dot adding unit, respectively, a binary image of a region that has been subjected to screening in the image received by the image receiving unit.

6. The image processing apparatus according to claim 2, further comprising
a binary-image generating unit that generates, on the basis of the screen information received by the screen-information receiving unit and a result of the halftone-dot extraction process and the halftone-dot addition process performed by the halftone-dot extraction unit and the halftone-dot adding unit, respectively, a binary image of a region that has been subjected to screening in the image received by the image receiving unit.

7. The image processing apparatus according to claim 1, further comprising
a multiple-value-image generating unit that generates, on the basis of the screen information received by the screen-information receiving unit and a result of the halftone-dot extraction process and the halftone-dot addition process performed by the halftone-dot extraction unit and the halftone-dot adding unit, respectively, a multiple-value image of a region that has been subjected to screening in the image received by the image receiving unit.

8. The image processing apparatus according to claim 2, further comprising
a multiple-value-image generating unit that generates, on the basis of the screen information received by the screen-information receiving unit and a result of the halftone-dot extraction process and the halftone-dot addition process performed by the halftone-dot extraction unit and the halftone-dot adding unit, respectively, a multiple-value image of a region that has been subjected to screening in the image received by the image receiving unit.

9. The image processing apparatus according to claim 1,
wherein the screen-information reception process, the pixel-block extraction process, the halftone-dot extraction process, and the halftone-dot addition process are performed on a first region by the screen-information receiving unit, the pixel-block extraction unit, the halftone-dot extraction unit, and the halftone-dot adding unit, respectively, the first region being a region of the image received by the image receiving unit,
wherein the screen-information reception process, the pixel-block extraction process, the halftone-dot extraction process, and the halftone-dot addition process are performed on a second region by the screen-information receiving unit, the pixel-block extraction unit, the halftone-dot extraction unit, and the halftone-dot adding unit, respectively, for pixel blocks having a color different from a color of the first region, the second region being a region of the image received by the image receiving unit,
wherein the image processing apparatus further comprises
a screen-information determination unit that determines, on the basis of screen information received by the screen-information receiving unit for the first region and screen information received by the screen-information receiving unit for the second region, screen information concerning screening which has been performed on the image received by the image receiving unit, and
a combining unit that combines a result of the halftone-dot extraction process and the halftone-dot addition process which have been performed on the first region by the halftone-dot extraction unit and the halftone-dot adding unit, respectively, and a result of the halftone-dot extraction process and the halftone-dot addition process which have been performed on the second region by the halftone-dot extraction unit and the halftone-dot adding unit, respectively, with each other, and
wherein the halftone-dot extraction unit and the halftone-dot adding unit perform the halftone-dot extraction process and the halftone-dot addition process, respectively, on the basis of the screen information determined by the screen-information determination unit.

10. The image processing apparatus according to claim 1,
wherein the screen-information reception process, the pixel-block extraction process, and the halftone-dot extraction process are performed on a first region by the screen-information receiving unit, the pixel-block extraction unit, and the halftone-dot extraction unit, respectively, the first region being a region of the image received by the image receiving unit,
wherein the screen-information reception process, the pixel-block extraction process, and the halftone-dot extraction process are performed on a second region by the screen-information receiving unit, the pixel-block extraction unit, and the halftone-dot extraction unit, respectively, for pixel blocks having a color different from a color of the first region, the second region being a region of the image received by the image receiving unit,
wherein the image processing apparatus further comprises
a screen-information determination unit that determines, on the basis of screen information received by the screen-information receiving unit for the first region and screen information received by the screen-information receiving unit for the second region, screen information concerning screening which has been performed on the image received by the image receiving unit, and
a combining unit that combines a result of the halftone-dot extraction process which has been performed on the first region by the halftone-dot extraction unit and a result of the halftone-dot extraction process which has been performed on the second region by the halftone-dot extraction unit with each other, thereby performing a combining process,
wherein the halftone-dot adding unit adds, on the basis of the screen information determined by the screen-information determination unit, for a result of the combining process performed by the combining unit, a halftone dot at a position at which no pixel block has been extracted by the pixel-block extraction unit, and
wherein the halftone-dot extraction unit performs the halftone-dot extraction process on the basis of the screen information determined by the screen-information determination unit.

11. The image processing apparatus according to claim 1, wherein the halftone-dot extraction unit determines, using a criterion based on the number of pixel blocks that exist around a target position and that have a color different from a color of a pixel block which exists at the target position, whether or not a halftone dot is supposed to exist at the target position.

12. An image processing method comprising:
receiving an image;
receiving screen information concerning screening which has been performed on the received image;
extracting pixel blocks which are possibly halftone dots included in the received image;
extracting, on the basis of the received screen information, a pixel block which is a halftone dot among the extracted pixel blocks; and
adding, on the basis of the received screen information, a halftone dot at a position at which no pixel block has been extracted.

13. A computer-readable medium storing a program causing a computer to execute a process for processing an image, the process comprising:
receiving an image;
receiving screen information concerning screening which has been performed on the received image;
extracting pixel blocks which are possibly halftone dots included in the received image;
extracting, on the basis of the received screen information, a pixel block which is a halftone dot among the extracted pixel blocks; and
adding, on the basis of the received screen information, a halftone dot at a position at which no pixel block has been extracted.
